(19) United States
(12) Patent Application Publication
(10) Pub. No.: US 2023/0103922 A1
(43) Pub. Date: Apr. 6, 2023

(54) CONTROLLING PRODUCE RIPENING DURING TRANSIT

(71) Applicant: Apeel Technology, Inc., Goleta, CA (US)

(72) Inventors: Amy Louise Keech, Goleta, CA (US); Amy Jefferson, Goleta, CA (US)

(21) Appl. No.: 17/816,565

(22) Filed: Aug. 1, 2022

Related U.S. Application Data
(60) Provisional application No. 63/249,157, filed on Sep. 28, 2021.

(51) Int. Cl. A23B 7/152; A23L 3/36; A23L 3/3445; A23L 3/3589; A23B 7/04; A23B 7/158

(52) U.S. Cl. CPC A23B 7/152; A23L 3/363; A23L 3/3445; A23L 3/3589; A23B 7/0425; A23B 7/158; A23V 2002/00

(57) ABSTRACT

Described herein are systems and methods for ripening produce in a container during transit. The method includes maintaining, by a controller, an initial refrigerated climate in the container, detecting a first climate modification event, controlling automated vents in the container to an open state that exposes an interior of the container to an external environment until a temperature within the container increases to a predetermined temperature value, controlling, when the temperature reaches the predetermined temperature value, a ripening agent generator to inject a ripening agent into the container, continuously monitoring and controlling the ripening agent generator to maintain a target concentration of the ripening agent, detecting a second climate modification event, controlling the ripening agent generator to stop injecting the ripening agent, controlling a refrigeration unit to lower the container temperature to the initial refrigerated climate, and maintaining the initial refrigerated climate until arrival at a destination location.

### CROSS REFERENCE TO RELATED APPLICATIONS

This application claims priority to U.S. Provisional Application Ser. No. 63/249,157, filed on Sep. 28, 2021, the disclosure of which is incorporated by reference in its entirety.

### TECHNICAL FIELD

This document describes devices, systems, and methods related to controlling the ripening of produce, such as fruits and/or vegetables, while in transit.

### BACKGROUND

Produce, such as fruits, vegetables, and/or other products that ripen and/or otherwise change their state or composition over time, can be moved from an origin location to a destination location. Transit can sometimes range from a few days to several weeks or even months. The produce can be moved in different types of containers, depending on how long transit may be. For example, some produce can be moved in cold storage containers, which can be used for shorter trips. A short trip can be 7 days from harvest to a grocery store. Some produce can be moved in controlled atmosphere containers, such as shipping containers and/or reefers, for longer trips. A long trip can be 2 or more weeks from harvest to grocery store. Controlled atmosphere containers have components and mechanisms that provide for moderating gas composition of a climate inside the containers. By moderating the climate, produce being transported by such containers can remain fresh during transit so that they are not spoiled or rotten by the time they reach their destination. This controlled climate also can provide protection against unexpected transit delays, such that the produce can arrive to its destination in a fresh state.

### SUMMARY

The document generally relates to technology for controlling the ripening of produce, such as fruits, vegetables, and/or other products that ripen and/or otherwise change their state or composition over time, while in transit, such as in a container carried by a ship, truck, train, or other mode of transportation. The disclosed technology can provide for selectively modifying a climate within an enclosed container (e.g., shipping container) containing produce to control the ripening of the produce so that the produce is at a target state of ripeness when it arrives at a destination location, such as a port, a distribution center, a grocery store, and/or an end consumer location (e.g., restaurant, home). The selective climate control of a container can include, for example, modifying the climate to accelerate or increase the rate of ripening for produce in the container, to decelerate or decrease the rate of ripening for the produce, and/or to maintain a current rate of ripening for the produce. The selective climate control can be performed in advance of arriving at a destination location so that, upon arriving at the destination location, the produce is at a target state of ripeness. Accordingly, selective climate control to increase, decrease, and/or maintain the current state of ripening can be performed based on a current location, a destination location, a rate of travel, and/or the estimated time remaining until the container arrives at the destination location. The selective climate control can, additionally, be modified based on variations in detected conditions from an estimated and/or projected condition, such as variations in an estimated transit schedule (e.g., transit delays) and/or ripening of the produce (e.g., produce ripens at faster or slower rate than projected). For example, if impediments to arriving at the destination location at a target time occur (e.g., traffic, bad weather), selective climate control of the container can be modified so that the ripening of the produce is slowed to avoid over-ripening of the produce when it arrives at the destination location. In another example, the ripeness of the produce can be determined through one or more sensors contained within a container and, if the detected ripeness of the produce is outside an target range, the climate control can be modified to achieve those target values.

In an illustrative example, fruit can be shipped overseas in a shipping container. The shipping container can include controlled atmosphere technology as well as a self-contained ripening agent unit that can be integrated into the shipping container. The self-contained ripening agent unit can include ripening agent sensors and a ripening agent generator which can generate a ripening agent for one or more produce items in the container, such as a ripening agent that includes ethylene gas. The levels of such a ripening agent within the container can be selectively adjusted (e.g., increased, decreased, maintained) as the container reaches one or more target locations (e.g., threshold distance from destination, threshold time from arrival), and the ripeness of the produce can be determined using the ripening agent sensors to further determined adjustments to the ripening agent levels within the container. Adjusting the ripening agent levels can include, for instance, increasing the ripening agent concentrations within the container (e.g., activating the ripening agent generator) and/or decreasing the ripening agent concentrations (e.g., venting the ripening agent from the container). Various control feedback loops can be used to determine appropriate ripening agent levels within the container at points in time during transit of the container, such as based on concentrations of ripening agent within the container, detected levels of ripeness of the produce, and/or a current location of a container relative to a destination location (and/or transit path).

For example, using the disclosed technology, the shipping container's climate can be modified when the shipping container is within a certain distance (e.g., actual distance, time, etc.) from the destination location. Modifying the climate can include causing the shipping container to warm to a predetermined temperature and/or humidity level then injecting a ripening agent, such as ethylene gas, into the shipping container. Ripeness of the fruits can be monitored while the ripening agent is injected into the container. Based on how quickly or how slowly the fruits ripen, an amount of ripening agent in the container can be adjusted. Once it is determined that the fruits are ripe, the climate of the shipping container can be modified again. For example, the ripening agent can be expelled from the shipping container and the shipping container can be returned to a refrigerated state for the rest of the transit until arrival at the destination location.

Modifying the climate can be based on numerous factors. For example, the climate can be modified based on a distance from a current location of the shipping container to the destination location, unexpected conditions such as weather or traffic that can cause delays in arrival at the destination location, a place of origin of the produce, ripening information about the produce, a rate at which the produce ripen or spoil, an amount of time that the produce can remain fresh, a ratio of carbon dioxide (CO₂) to oxygen (O₂) levels in the shipping container, a temperature of the container, a rate of respiration for the produce, humidity levels in the shipping container, and/or a concentration of the ripening agent within the container.

Particular embodiments described herein include a method for ripening produce in a container during transit, the method can include maintaining, by a controller, an initial refrigerated climate in the container while the container is in transit to a destination location and contains the produce, detecting, by the controller, a first climate modification event during transit of the container to the destination location, and controlling, by the controller and in response to detecting the first climate modification event, one or more automated vents in the container to an open state that exposes an interior of the container to an external environment. The automated vents can be maintained in the open state until a temperature within the container increases from an initial refrigerated climate to at least a predetermined temperature value. The method can also include controlling, by the controller and in response to the temperature in the container reaching the predetermined temperature value, a ripening agent generator to inject a ripening agent into the container, continuously monitoring and controlling, by the controller, the ripening agent generator to maintain a target concentration of the ripening agent in the container, detecting, by the controller, a second climate modification event, controlling, by the controller and in response to detecting the second climate modification event, the ripening agent generator to stop injecting the ripening agent into the container, controlling, by the controller, a refrigeration unit to activate to lower the temperature in the container to the initial refrigerated climate, and maintaining, by the controller, the initial refrigerated climate until arrival at a destination location of the container.

In some implementations, the method can optionally include one or more of the following features. For example, the ripening agent can be ethylene gas. As another example, detecting (i) the first climate modification event and (ii) the second climate modification event can include receiving, by the controller and from a variety of sensors positioned throughout the container, indications of at least one of temperature, humidity, CO₂, O₂, ripening agent, and ripeness level in the container. The initial refrigerated climate can include a temperature range of 0° Celsius to 5° Celsius. The predetermined temperature value can include a temperature range of 15° Celsius to 22° Celsius. The ripening agent can be injected into the container at a rate between 1 ppm and 200 ppm.

In some implementations, the method can also include receiving, by the controller and from the variety of sensors, indications of CO₂ and O₂ levels in the container, determining, by the controller and based on the CO₂ and O₂ levels, a ratio of CO₂ to O₂ in the container, and controlling, by the controller and based on the ratio of CO₂ to O₂ exceeding a threshold ratio range, one or more of the vents to open to adjust levels of one or more of the CO₂ and the O₂ in the container.

As another example, detecting a first climate modification event can include receiving, by the controller, information about a current location of the container, a travel route, and the destination location, identifying, by the controller and based on the information, travel conditions along the travel route from the current location of the container to the destination location, predicting an estimated remaining time in transit from the current location of the container to the destination location, and detecting, by the controller, the first climate modification event based on the estimated remaining time in transit being within a threshold arrival range. Moreover, (i) the identified travel conditions can include weather conditions and traffic along the travel route and (ii) the information about the current location of the container can include a GPS location of the container.

As another example, controlling a ripening agent generator to inject a ripening agent into the container can include receiving, by the controller and from one or more sensors in the container, indications of a ripeness level of the product, receiving, by the controller, information about the product in the container that includes a place of origin, a period of time for ripening, and a type of the product, determining, by the controller, that the ripeness level of the product corresponds to the received information about the product, and controlling, by the controller and based on determining that the ripeness level of the product corresponds to the received information about the product, the ripening agent generator to stop injecting the ripening agent into the container.

In some implementations, the method can also include coating the produce before transit in the container in a shelf-life extension coating solution. In some implementations, the threshold ratio range can be 6% CO₂ to 4% O₂. In yet some implementations, detecting a first climate modification event can include determining, by the controller, that a distance between a current location of the container and the destination location is within a threshold distance range. The threshold arrival range can be three days from arrival to the destination location.

In some implementations, continuously monitoring a concentration of the ripening agent in the container can include controlling, by the controller and based on the concentration of the ripening agent exceeding a threshold ripening range, one or more of the vents to open to release a predetermined amount of the ripening agent from the container. The method can further include controlling, by the controller and based on the concentration of the ripening agent being less than the threshold ripening range, the ripening agent generator to inject an additional predetermined quantity of the ripening agent into the container. In some implementations, detecting a second climate modification event can include determining, by the controller, that the concentration of the ripening agent is within the threshold ripening range.

One or more preferred embodiments described herein can also include a system for ripening a product in a container during transit, the system including a container for storing the product in transit and a self-contained ripening agent unit for ripening the product in the container during transit. The container can include a variety of sensors, a variety of vents, and a first controller that can receive information from the sensors and control the vents. The self-contained ripening agent unit can have at least one ripening agent sensor, a ripening agent generator, and a second controller that can receive information from the at least one ripening agent sensor and control the ripening agent generator. The second controller can be in communication with the first controller and can maintain an initial refrigerated climate in the container while the container is in transit to a destination location and contains the product, detect a first climate modification event during transit of the container to the destination location, and control, in response to detecting the first climate modification event, one or more automated vents in the container to an open state that exposes an interior of the container to an external environment. The automated vents can be maintained in the open state until a temperature within the container increases from an initial refrigerated climate to at least a predetermined temperature value. The second controller can also control, in response to the temperature in the container reaching the predetermined temperature value, a ripening agent generator to inject a ripening agent into the container, continuously monitor and control the ripening agent generator to maintain a target concentration of the ripening agent in the container, detect a second climate modification event, control, in response to detecting the second climate modification event, the ripening agent generator to stop injecting the ripening agent into the container, control a refrigeration unit to activate to lower the temperature in the container to the initial refrigerated climate, and maintain the initial refrigerated climate until arrival at a destination location of the container.

In some implementations, the system can optionally include one or more of the abovementioned features.

One or more preferred embodiments described herein can also include a system for ripening a product in a container during transit, the system including a container for storing the product in transit. The Container can include sensors, vents, a ripening agent generator, and a controller that can receive information from the sensors and control the vents and the ripening agent generator. The controller can maintain an initial refrigerated climate in the container, while the container is in transit to a destination location and contains the product, detect a first climate modification event during transit of the container to the destination location, and control, in response to detecting the first climate modification event, one or more automated vents in the container to an open state that exposes an interior of the container to an external environment. The automated vents can be maintained in the open state until a temperature within the container increases from an initial refrigerated climate to at least a predetermined temperature value. The controller can also control, in response to the temperature in the container reaching the predetermined temperature value, a ripening agent generator to inject a ripening agent into the container, continuously monitor and control the ripening agent generator to maintain a target concentration of the ripening agent in the container, detect a second climate modification event, control, in response to detecting the second climate modification event, the ripening agent generator to stop injecting the ripening agent into the container, control a refrigeration unit to activate to lower the temperature in the container to the initial refrigerated climate, and maintain the initial refrigerated climate until arrival at a destination location of the container.

In some implementations, the system can optionally include one or more of the abovementioned features.

The devices, system, and techniques described herein may provide one or more of the following advantages. For example, the disclosed technology can improve supply chains. Produce can be ripened during transit. This can save time in the supply chain that otherwise might have been used to ripen the produce before or after they are in transit. Supply chains can therefore become more efficient since the produce can be ripened simultaneously as they are in transit. Therefore, transit time can be optimized and used to ripen the produce.

Supply chains can also be improved because the disclosed technology can provide for more produce remaining fresh during transit. As a result, fewer or no produce may be spoiled by the time they reach their destination location. Sometimes, produce can ripen at different rates, especially if such produce require different ripening conditions and/or a climate within a shipping container is not uniformly or continuously monitored and adjusted. This can cause some produce to ripen too quickly or too slowly. Some produce may also spoil before or by the time that they arrive at the destination location. When this occurs, the produce may not be sold to consumers, which can create inefficiencies and losses in the supply chain. The disclosed technology, on the other hand, can provide for uniform and continuous monitoring of both climate and ripening conditions within shipping containers. With such uniform and continuous monitoring, the disclosed technology can provide for more uniform distribution of a ripening agent within an ideal time range before arrival at the destination location. As a result of distributing the ripening agent using the techniques described herein, more of the produce can be uniformly and consistently ripened for the remaining duration of transit. Freshness of the produce may also be maintained based on continuous monitoring and adjustment of the controlled atmosphere during transit (e.g., before distribution of the ripening agent). As a result, smaller or no quantities of produce may be spoiled or eliminated by the time they reach the destination location.

Implementing the disclosed technology can come at a minimal cost. Existing controls and mechanisms within the shipping container can be used to monitor and control environmental conditions within the shipping container. An additional ripening agent generator can be added to the shipping container and coupled with the existing components of the container to ripen the produce. In some implementations, a self-contained ripening agent unit can be added to any existing shipping containers. The self-contained unit can also be moved from one shipping container to another, depending on which container has produce that require ripening during transit. Therefore, the disclosed technology can be easily deployable at a low cost to the supply chain.

As another example, the disclosed technology can be used to make produce last longer. Using continuously monitored concentrations of a ripening agent in a controlled environment, the disclosed technology can provide for more precise monitoring of product conditions. Such monitoring can be advantageous to provide optimal quantities of the ripening agent that ripens the produce before arrival at the destination location without causing the produce to spoil by the time they arrive at the destination location. In some implementations, the produce can also be coated in a solution that can further make the produce last longer and fresher during transit. The solution can be a shelf-life extension coating solution. The solution can also be a wax coating or similar types of coating solutions.

The disclosed technology can also improve consumer approval of the produce that are transported from harvest to store. As described above, the disclosed technology can provide for ripening produce and maintaining their freshness for a duration of transit. The produce can arrive at the store both ripe and fresh for purchase by consumers. Since fewer produce may be spoiled, over-ripened, or under-ripened, more ripe and fresh produce can be put on the shelves for consumers to purchase. Consumers may likely continue to purchase the produce that appear ripe and fresh from use of the disclosed technology in comparison to produce that are not ripened and maintained using the disclosed technology.

The details of one or more implementations are set forth in the accompanying drawings and the description below. Other features and advantages will be apparent from the description and drawings, and from the claims.

### BRIEF DESCRIPTION OF THE DRAWINGS

FIG. 1A is a conceptual diagram of modifying an environment of a shipping container using the techniques described herein.

FIG. 1B is a conceptual diagram of modifying the environment of the shipping container with a ripening agent to ripen produce in the shipping container.

FIG. 2A is a system diagram of a shipping container with ripening agent components integrated therein.

FIG. 2B is a system diagram of a shipping container with a self-contained ripening agent unit attached thereto.

FIGS. 3A-B is a flowchart of a process for modifying a climate of a shipping container to ripen produce therein.

FIGS. 4A-D is a flowchart of a process for modifying a climate of a shipping container with a ripening agent to ripen produce therein.

FIGS. 5A-B are flowcharts of processes for setting an initial climate of the shipping container.

FIG. 6 is a flowchart of a process for determining arrival at a destination location.

FIG. 7 is a flowchart of a process for modifying a climate of the shipping container based on remaining time in transit to the destination location.

FIG. 8 is a flowchart of a process for modifying a climate of the shipping container based on a remaining distance from the destination location.

FIGS. 9A-B is a flowchart of a process for modifying a climate of the shipping container based on predicted travel conditions.

FIG. 10 is a flowchart of a process for modifying a climate of the shipping container based on product ripening information.

FIG. 11 is a flowchart of a process for modifying a climate of the shipping container based on monitored ripening conditions of produce in the shipping container.

FIG. 12 is a graphical depiction of firmness of ethylene-ripened avocados versus ambient-ripened avocados.

FIG. 13 is a graphical depiction of firmness of ethylene-ripened treated avocados versus untreated avocados.

FIG. 14 is a schematic diagram that shows an example of a computing device and a mobile computing device.

Like reference symbols in the various drawings indicate like elements.

### DETAILED DESCRIPTION OF ILLUSTRATIVE EMBODIMENTS

This document generally relates to systems and methods for ripening produce, such as fruits, while in transit to a destination location. The produce can be ripened using a ripening agent, such as ethylene gas. The ripening agent can be dispersed within a shipping container over a predetermined period of time and based on numerous factors related to environmental conditions of the shipping container and product ripening information. One or more components for ripening the produce can be integrated into the shipping container. One or more components for ripening the produce can also be part of a self-contained unit that can be attached to the shipping container and in communication with one or more controls and mechanisms integrated within the shipping container.

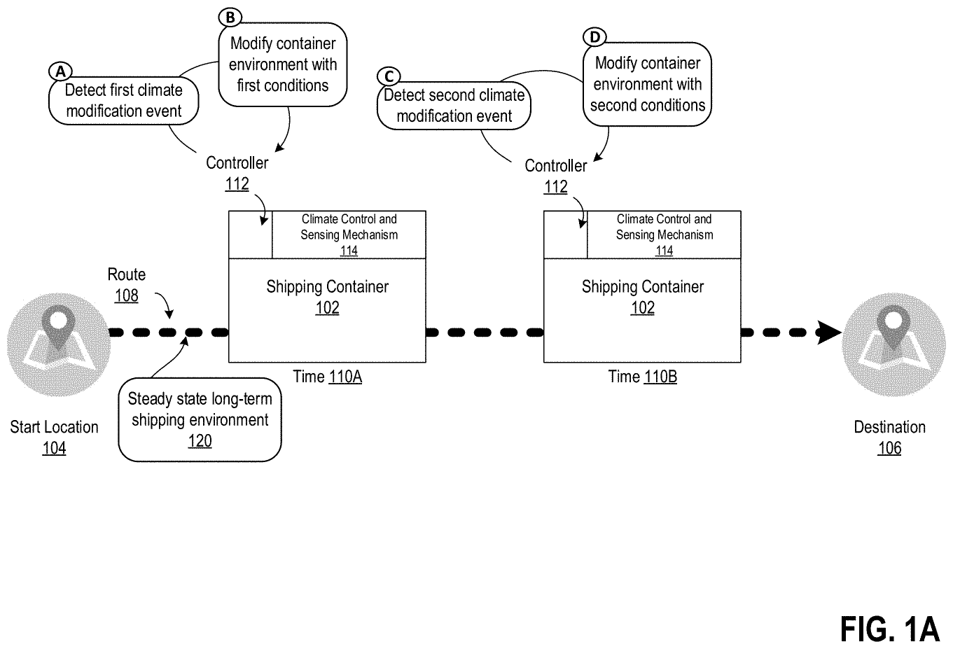

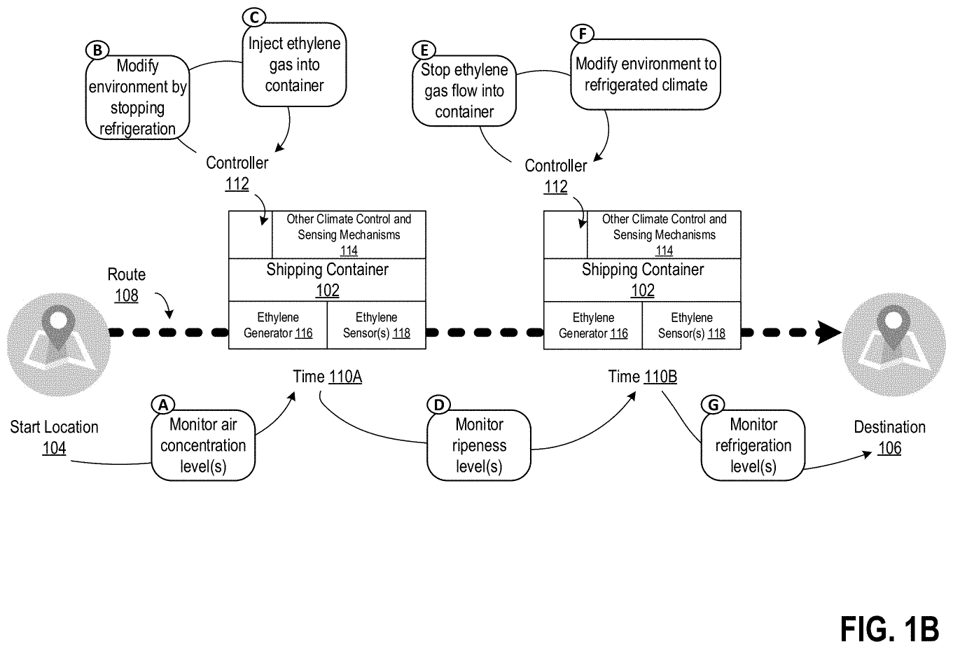

Referring to the figures, FIG. 1A is a conceptual diagram of modifying an environment of a shipping container 102 using the techniques described herein. The shipping container 102 can be one or more different types of vessels for transporting produce, such as fruits and vegetables, from harvest to stores or other destination locations. For example, the container 102 can be a cold storage container. The container 102 can also be a controlled atmosphere, such as in reefers or other large containers. The shipping container 102 can include a controller 112 and a climate control and sensing mechanism 114. The controller 102 can be configured to control one or more components in the shipping container 102 that can be used to adjust or modify the environment (e.g., climate) of the container 102. The climate control and sensing mechanism 114 can include a plurality of different types of sensors (e.g., temperature, humidity, etc.), vents (e.g., inlets/outlets), fans, generators, CO₂ scrubbers, HVAC system, and other active and passive systems that can be used to modify the environment of the container 102.

As shown in FIG. 1A, the container 102 can be transported along a route 108 from a start location 104 to a destination location 106. In some examples, the container 102 can be transporting fresh produce from a farm (the start location 104) to a grocery store (the destination 106). Along the route 108, a steady state long-term shipping environment 120 can be maintained. The steady state long-term shipping environment 120 can be a controlled atmosphere. Modifications can also be made to the environment of the container 102 while the container 102 is in transit along the route 108 from the start location 104 to the destination location 106.

Modifications to the environment can be made at different times, such as times 110A and 110B. At time 110A, the controller 112 can detect a first climate modification event (A). The first climate modification event can relate to the container 102 being within a certain distance from the destination location 106. As an illustrative example, the container 102 can be transporting avocados. The controller 112 can detect or be notified when the container 102 is approximately 3-4 days away from arriving at the destination 106, which can be the first climate modification event (A). At that point, the controller 112 can control one or more of the components of the climate control and sensing mechanism 114 to modify the container environment with first conditions (B). The first conditions can be based on conditions that are sensed inside the container 112 (e.g., there is too much O₂ and not enough CO₂ inside the container 102). The first conditions can also be based on conditions that are expected upon arrival at the destination 106 (e.g., the produce within the container 102 should be ripe by the time they arrive at the destination 106). In the avocado example, when the container 102 is 3-4 days away from the destination 106, the controller 112 can control components such as sensors, gas generators, and vents to make the environment of the container 102 conducive for ripening the avocados during transit before arriving at the destination 106. Thus, at time 110A, the container environment can be modified to begin a process for ripening the avocados (e.g., injecting a ripening agent into the container 102).

At time 110B, the controller 112 can detect a second climate modification event (C). The second climate modification event can be based on the container 102 being a certain distance or time away from the destination 106. The second climate modification event can also be based on conditions sensed within the container 102 (e.g., the produce ripened, too much of a ripening agent is being dispersed inside the container 102, too little of the ripening agent is being dispersed inside the container 102, etc.). Accordingly, the controller 112 can control one or more of the components of the climate control and sensing mechanism 114 to modify the container environment with second conditions (D). Thus, at time 110B, in the example of the avocados, the container environment can be modified to stop the ripening process for the avocados (e.g., removing the ripening agent from the container 102).

In some implementations, the controller 112 can be configured to modify the container environment more than two times. For example, produce therein can be ripened multiple times in stages, which can require multiple stages of environment modifications. The multiple stages of environment modifications can be one or more temperature control phases. For example, a first stage can be gradually raising a temperature in the container before exposing the produce to the ripening agent, a second stage can be maintaining a desired temperature in the container while exposing the produce to the ripening agent, and a third stage can be gradually lowering the temperature in the container after exposure to the ripening agent is complete. The multiple stages of environment modifications can also be one or more ripening agent control phases. For example, a first stage can be gradually increasing exposure to the ripening agent in the container, a second stage can be maintaining exposure to the ripening agent in the container, and a third stage can be gradually decreasing exposure to the ripening agent. One or more other stages of environment modifications are also possible and may be based on any one or more of a produce type, location of origin, and/or customer preference. As another example, the produce therein can be ripened once, however the climate of the container 102 may be modified multiple times to maintain a constant environment and based on sensed conditions within the container 102.

In some implementations, the controller 112 can receive information from other computing devices and/or systems that communicate (e.g., wired, wireless) over network(s). For example, the controller 112 can receive an indication or notification from a computing device at the start location 104 indicated an estimated time of arrival at the destination 106. The computing device at the start location 104 can also provide information that can instruct the controller 112 when to control one or more of the components of the climate control and sensing mechanism 114. The computing device at the start location 104 can determine times 110A and 110B and what modifications to make to the environment of the container 102 during any times along the route 108. In some implementations, the controller 112 can also determine the times 110A and 110B and/or necessary modifications to make to the container environment without communicating with another computing device or system.

FIG. 1B is a conceptual diagram of modifying the environment of the shipping container 102 with a ripening agent to ripen produce in the shipping container 102. Like the container 102 in FIG. 1A, the container 102 in FIG. 1B can be moving along the route 108 from the start location 104 to the destination 106. The container 102 can include the controller 112, which can be the same or different from the controller in FIG. 1A, other climate control and sensing mechanisms 114, an ethylene generator 116, and ethylene sensor(s) 118. The shipping container 102 in FIG. 1B includes additional components that can be used for ripening the produce transported therein. As described throughout this disclosure, concentrations of the ripening agent (e.g., ethylene gas) can be used to modify an environment of the shipping container 102, thereby causing the produce therein to ripen during transit to the destination 106.

The controller 112 can monitor air concentration level(s) from the start location 104 to the time 110A (A). Based on the monitored level(s) at time 110A, the controller 112 can cause one or more of the mechanisms 114 to modify the environment by stopping refrigeration (B). Produce, such as fruits and vegetables, can be transported in a refrigerated state from the start location 104 to the destination location 106. As described herein, it can be preferred to ripen the produce in normal air concentrations or a predetermined ratio of CO₂ to O₂ and/or temperature range rather than in the refrigerated state. Therefore, modifying the environment of the container 102 in B can include increasing a temperature of the container 102 and maintaining that temperature 102 for a predetermined amount of time. The temperature can be increased to a predetermined value. In some implementations, the predetermined temperature value can be any value within a range of 10° Celsius to 22° Celsius. The predetermined temperature value can also vary depending on one or more factors, including but not limited to seasonality, shipment duration, produce information, and customer specifications/preferences (e.g., the customer requested a particular ripening process and/or final firmness of the produce upon arrival at the destination location). The predetermined temperature or temperature range value can correspond to normal air concentrations. The predetermined amount of time can correspond to an amount of time needed to complete the ripening process described herein. Once the environment is modified (e.g., the desired temperature or temperature range is reached in the container 102), the controller 112 can instruct the ethylene generator 116 to inject the ripening agent into the container 102(C).

From time 110A to time 110B, the controller 112 can monitor ripeness level(s) of the produce in the container 102(D). For example, one or more of the ethylene sensor(s) 118 and/or the mechanisms 114 can sense conditions of the produce and/or air and gas concentration levels within the container 102. As another example, ripeness level(s) can be monitored based on identifying how much time has passed since the ripening process began in C and how much time remains in the ripening process. Therefore, ripeness level(s) can be inferred based on time.

Based on the monitored ripeness level(s), at time 110B, the controller 112 can instruct the ethylene generator 116 to stop the ripening agent flow into the container 102(E). Stopping the ripening agent flow can also include opening vents in the container 102 to air out any ripening agent in the container environment. The controller 112 can instruct one or more of the mechanisms 114 to modify the environment to a refrigerated climate (F). For example, a refrigeration or cooling unit can be instructed to cool the container environment until a desired refrigeration temperature is achieved. Fans can also be actuated to circulate the cooled air throughout the container environment.

It can be preferred to maintain the container 102 in a refrigerated state for the remaining duration of time to the destination 106 to preserve ripeness and freshness of the produce. Thus, from time 110B to arrival at the destination 106, one or more components, such as the mechanisms 114, can sense conditions in the container environment and communicate those to the controller 112. The controller 112 can use those sensed conditions to monitor refrigeration level(s) of the container (G). Monitoring the refrigeration level(s) of the container 102 can include adjusting temperature and/or humidity values in the container 102 such that they remain within threshold refrigeration ranges. Thus, the controller 112 can ensure that modifications are made in real-time to the container environment to maintain a preferred refrigerated state until arrival at the destination location 106.

As described in reference to FIG. 1A, the controller 112 can be configured to modify the environment of the container 102 at one or more additional times and/or based on one or more different conditions. The different conditions can include delays in travel as well as sensed changes in the container's environment and/or ripeness or freshness of the produce.

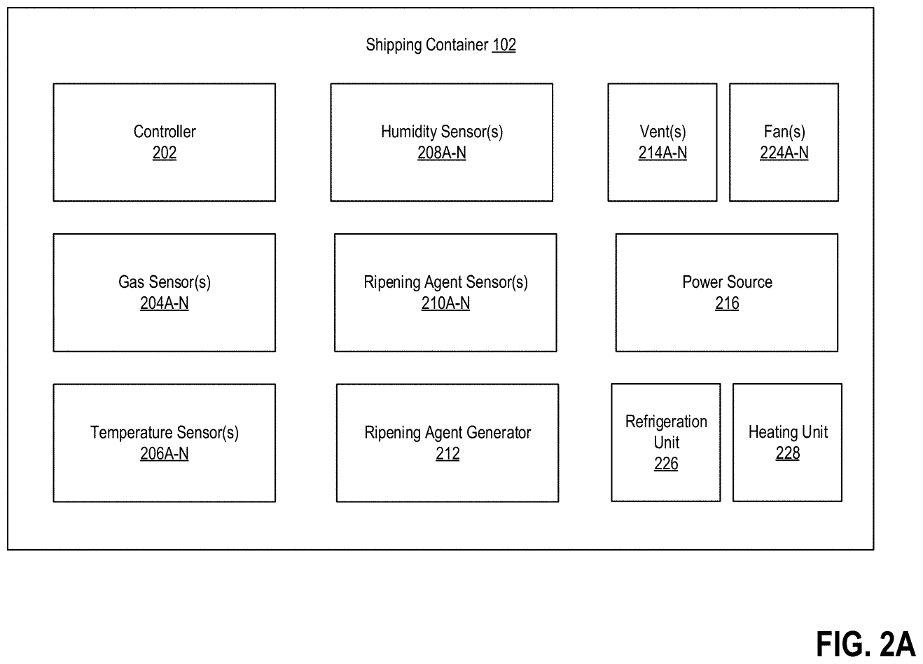

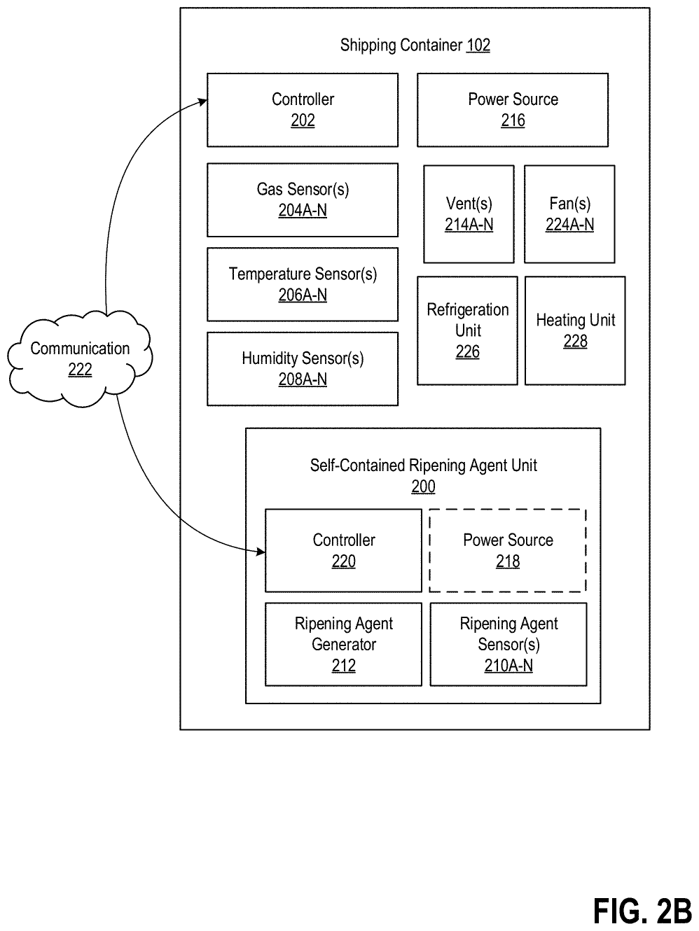

FIG. 2A is a system diagram of a shipping container 102 with ripening agent components integrated therein. The shipping container 102, as described herein, can be a reefer or other controlled atmosphere container. The container 102 can include components such as a controller 202, gas sensor(s) 204A-N, temperature sensor(s) 206A-N, humidity sensor(s) 208A-N, ripening agent sensor(s) 210A-N, ripening agent generator 212, vent(s) 214A-N, fan(s) 224A-N, power source 216, refrigeration unit 226, and a heating unit 228. The container 102 can include one or more additional or fewer components (e.g., CO₂ scrubbers) that can be used for modifying an environment of the container 102. The sensors 204A-N, 206A-N, 208A-N, and 210A-N can be in communication with (e.g., wired and/or wireless) or otherwise connected to the controller 202. The controller 202 can use the information received from the sensors 204A-N, 206A-N, 208A-N, and 210A-N to determine what modifications to make to the container environment and what components to instruct to make such modifications.

As described herein, the controller 202 can be configured to control one or more of the components within the shipping container 102 to modify the container's environment during transit. The controller 202 can include processor(s) to perform operations described herein. For example, the controller 202 can received sensed levels of nitrogen (N₂), CO₂, and/or O₂ from the gas sensor(s) 204A-N. Based on the sensed levels, the controller 202 can determine that additional levels of nitrogen need to be brought into the container to flush out excess levels of oxygen. The controller 202 can also determine whether a predetermined ratio of carbon dioxide to oxygen is met at different times in the container 102, which can ensure that the produce in the container 102 remain fresh and/or ripen. The controller 202 can therefore be configured to control a flow of gases in and out of the container 102.

The controller 202 can also be configured to control a temperature and/or humidity level of the container 102. For example, the controller 202 can receive sensed temperature and humidity values from the temperature sensor(s) 206A-N and the humidity sensor(s) 208A-N. Based on the sensed values, the controller 202 can determine whether the temperature and/or humidity levels should be changed within the container 102. The controller 202 can then instruct one or more components within the container 102 to actuate. For example, to lower the temperature in the container 102, the controller 202 can instruct one or more vent(s) 214A-N (e.g., air outlets) to open. The controller 202 can also instruct one or more fan(s) 224A-N to actuate, thereby directing air out through the vent(s) 214A-N. The controller 202 can also actuate a refrigeration unit 226 within the container 102 to cause cooled air to be distributed within the container 102.

The ripening agent generator 212 can be configured to actuate upon notification from the controller 202. As described herein, the controller 202 can determine that the produce within the container 102 are ready to undergo a ripening process. For example, the container 102 can be within a predetermined range (e.g., distance, time) from a destination location. It can be determined by the controller 202 or another computing device in communication with the controller 202 that the ripening process should occur during and within the predetermined range from the destination location. Therefore, once the container 102 is within the predetermined range, the controller 202 can be configured to actuate the ripening agent generator 212. The generator 212 can inject the ripening agent into the container until one or more of the sensors, such as the ripening agent sensor(s) 210A-N senses levels of the ripening agent that can indicate that the produce have ripened. The generator 212 can be industry-grade such that it is not flammable or harmful to the environment should the generator 212 tip over, spill, or otherwise malfunction while the container 102 is in transit.

The ripening agent sensor(s) 210A-N can be configured to sense levels of the ripening agent throughout the container 102. For example, the sensor(s) 210A-N can be positioned at corners of the container 102 to measure whether the ripening agent is being uniformly dispersed therein. The values sensed by the sensor(s) 210A-N can also be used to modulate how much of the ripening agent is released by the generator 212. The generator 212 can be configured to release increased or decreased amounts of the ripening agent into the container 102 depending on the sensed levels of the ripening agent therein. In situations where too much of the ripening agent is released in one area of the container 102, the controller 202 can instruct one or more vent(s) 214A-N to open in that area to release the ripening agent into the external environment. Likewise, the controller 202 can instruct one or more fan(s) 224A-N to turn on in that area to direct the ripening agent towards other areas of the container 102 where the sensed concentration of the ripening agent is lower.

The power source 216 can be configured to provide power to the components of the container 102 described herein. The power source 216 can be, for example, a battery or a rechargeable battery. One or more of the components, such as the controller 202, can have additional or separate power sources.

The refrigeration unit 226 can be configured to maintain a refrigerated state within the container 102. For example, the unit 226 can provide cooled air to the container 102. The heating unit 228 can be configured to maintain normal, ambient, environment states within the container 102. For example, the heating unit 228 can cause the container 102 to go from a refrigerated state to normal environment conditions. Once the container 102 is in the normal environment conditions, the ripening agent generator 212 can be actuated to begin the ripening process. Once the ripening process is complete, the generator 212 can be deactivated or turned off, the heating unit 228 can be turned off, and the refrigeration unit 226 can be actuated. Actuating the refrigeration unit 226 can cause the container environment to cool and preserve the ripened produce until arrival at the destination. The units 226 and 228 can be actuated and adjusted based on one or more factors, such as a ripeness level of the produce, sensed temperature values, sensed humidity values, a distance from the destination, a respiration rate of the produce, a freshness level of the produce, etc. In some implementations, the units 226 and 228 can be combined into a singular unit (e.g., HVAC unit). In some implementations, the container 102 can have only one of the units 226 and 228 (e.g., the container 102 can have just a refrigeration unit 226 or just a heating unit 228).

In some implementations, the container 102 can include one or more additional sensors, such as GPS sensors. Using values sensed by the additional sensors, the controller 202 can determine a current location of the container 102 and a remaining distance between the current location and the destination location. Based on the remaining distance, the controller 202 can determine modifications to the environment of the container 102 such that the produce can be ripened on time for arrival and/or preserved in a fresh and ripe state for arrival. The controller 202 can also be in communication with one or more computing devices or systems outside of the container 102, wherein such devices or systems can provide the controller 202 with information about a current location of the container 102, an estimated arrival at the destination location, product ripening information, and/or travel information.

FIG. 2B is a system diagram of a shipping container 102 with a self-contained ripening agent unit 200 attached thereto. The shipping container 102 can include the controller 202, gas sensor(s) 204A-N, temperature sensor(s) 206A-N, humidity sensor(s) 208A-N, power source 216, vent(s) 214A-N, fan(s) 224A-N, refrigeration unit 226, and heating unit 228. The self-contained ripening agent unit 200 can include components that can be used for releasing the ripening product within the container 102 and monitoring a ripening process therein. The unit 200 can be installed in any shipping container 102. Thus, the unit 200 can include a controller 220, the ripening agent generator 212, the ripening agent sensor(s) 210A-N, and an optional power source 218.

One or more components of the container 102 and the unit 200 can be in communication and/or fluidly connected. For example, the controller 220 of the unit 200 can be in communication 222 (e.g., wired and/or wireless, over a network) with the controller 202 of the container 102. The controller 202 can notify the controller 220 when the ripening process should begin. The controller 220 can then control components such as the ripening agent generator 212 to inject a ripening agent into the environment of the container 102. The sensors 204A-N, 206A-N, 208A-N, and 210A-N can sense environmental conditions and communicate them to both or either of the controllers 202 and 220. Based on the sensed conditions, the controller 220 can adjust injection levels of the ripening agent. The controller 220 can also send notifications to the controller 202 of the container 102 that one or more vent(s) 214A-N and/or fan(s) 224A-N should be turned on to disperse the ripening agent throughout the container 102. In some implementations, the controller 220 can be in direct communication with one or more of the sensors 204A-N, 206A-N, 208A-N, the vent(s) 214A-N, the fan(s) 224A-N, refrigeration unit 226 and heating unit 228. The controller 220 can then control such components without communicating to the controller 202 of the container 102. In some implementations, the self-contained ripening agent unit 200 can be coupled to the power source 216 of the container 102. In some implementations, as depicted, the unit 200 can have its own power source 218.

The ripening agent sensor(s) 210A-N can be configured to measure levels of the ripening agent throughout the container 102, as described herein. One or more of the ripening agent sensors 210A-N can also or alternatively be configured to measure ripeness levels of the produce inside the container 102. One or more additional sensors that are different from the ripening agent sensor(s) 210A-N can be configured to measure the ripeness levels of the produce.

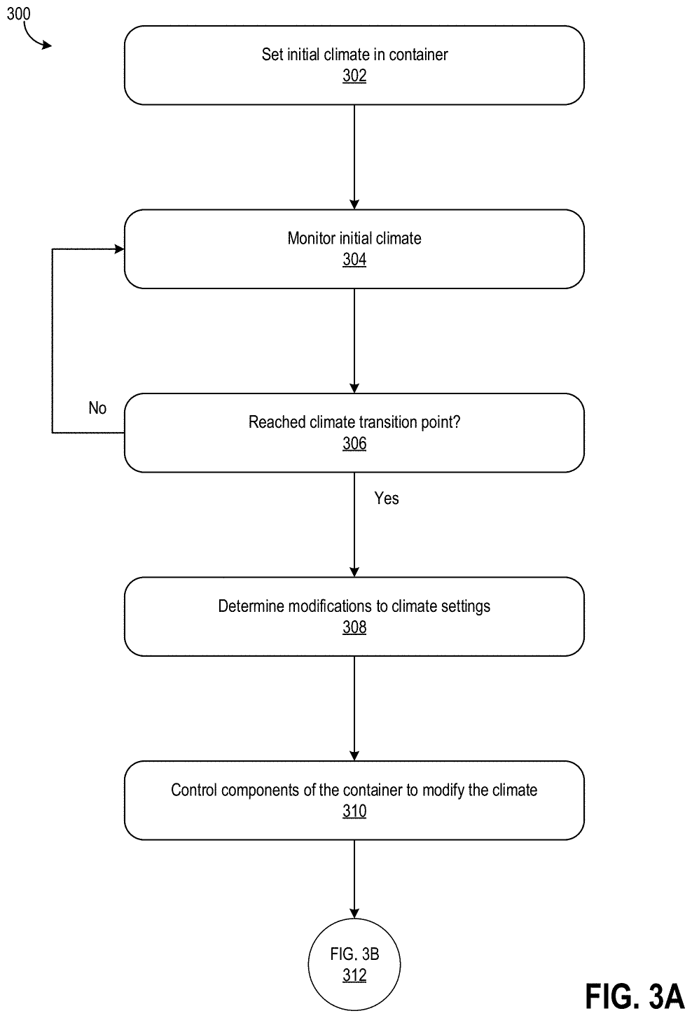

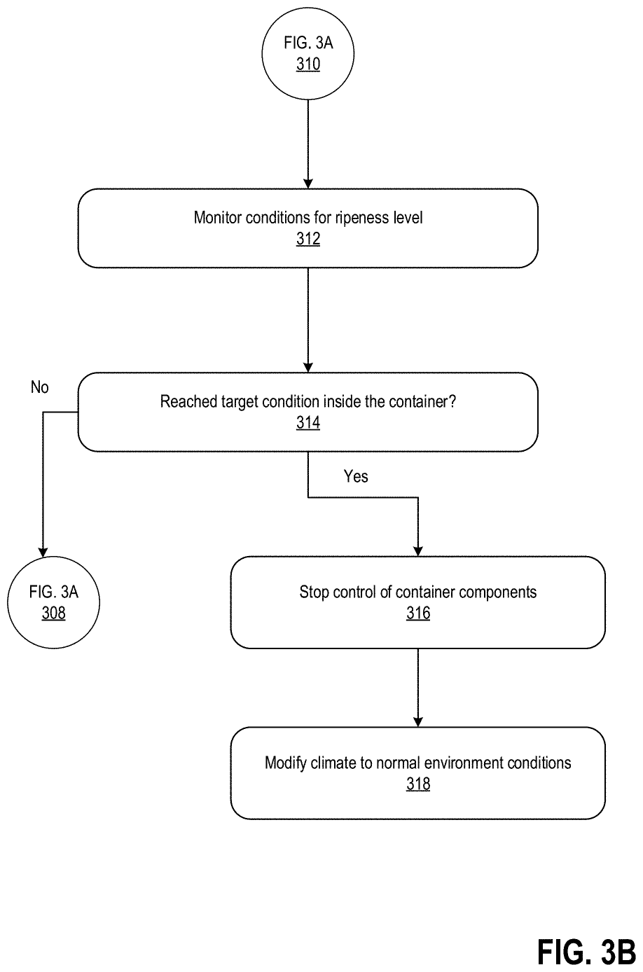

FIGS. 3A-B is a flowchart of a process 300 for modifying a climate of a shipping container to ripen produce therein. The process 300 can be performed by any one or more of the controllers described herein (e.g., the controller 112 in FIGS. 1A-B, the controller 202 in FIG. 2A, the controller 220 in FIG. 2B). For example, the process 300 can be performed by a controller that is integrated into a shipping container. The process 300 can also be performed by a controller that is part of a self-contained ripening agent unit. In some implementations, one or more blocks in the process 300 can be performed by other computing devices or systems that are integrated in the container and/or separate from the container. For illustrative purposes, the process 300 is described from a perspective of a controller.

Referring to the process 300 in both FIGS. 3A-B, the controller can set an initial climate in the container in 302. The initial climate can be a refrigerated state to preserve produce inside the container. For example, the refrigerated state can be a temperature value in the range of 0° Celsius to 5° Celsius.

The controller can monitor the initial climate in 304. For example, sensors in the container can sense levels of temperature, humidity, and/or gases in the container and communicate those sensed values to the controller. Based on those sensed values, the controller can determine whether the container has reached the initial climate state, whether the container is transitioning to the initial climate state too slowly, and/or whether the container is transitioning to the initial climate state too quickly.

The controller can determine whether the container has reached a climate transition point in 306. The transition point can indicate a time at which to begin a ripening process. Determining whether the climate transition point has been reached can be based on whether the sensed values in the container indicate that the initial climate has been reached (e.g., a desired, normal air temperature has been reached that is warmer than a refrigerated state temperature). This determination can also be based on whether the container is within a predetermined range (e.g., distance, time) from a destination location. For example, this determination can be based on an expected arrival at the destination being within a threshold time range.

If the transition point has not been reached, the controller can return to monitoring the initial climate in 304. The controller can continue to monitor the container environment. In some implementations, the controller can cause components of the container to actuate, thereby adjusting the environment of the container.

If the transition point has been reached, then the controller can determine what modifications to make to the climate settings of the container in 308. The controller can, for example, determine that the container should transition to a warmer environment and/or a ripening agent should be injected into the container. The controller can determine which components of the container should be actuated or deactivated in order to accomplish the determined climate settings.

The controller can control components of the container to modify the climate based on the determined modifications in 310. For example, the controller can instruct a refrigeration unit to turn off and then instruct a heating unit to turn on, thereby increasing a temperature inside the container (e.g., from 5° Celsius to 18° Celsius). Increasing the temperature inside the container can prep the container for a ripening process to begin. As another example, the controller can instruct one or more vents to open to bring O₂ into the container. A desired ratio of CO₂ to O₂ can then be maintained and/or achieved. As yet another example, the controller can instruct a ripening agent generator to actuate and inject the ripening agent into the container, as described herein.

How much to control the components can be based on predetermined values, sensed conditions inside the container, and/or information about the produce' origin(s), how quickly the produce ripen, how the produce ripen, and other factors. For example, the controller can instruct the refrigeration unit to remain turned on for a predetermined amount of time. Once the predetermined amount of time is satisfied, the controller can instruct the heating unit to actuate for a predetermined amount of time and instruct the refrigeration unit to turn off. The controller can also dynamically control the components described herein based on sensed real-time conditions in the container. For example, the controller can instruct the vents to remain open until one or more gas sensors within the container detect a ratio of CO₂ to O₂ that is preferred for the container environment. The controller can instruct the refrigeration unit to turn off until the container reaches another climate transition point (e.g., based on time or distance to the destination), until the controller determines that the produce inside the container have ripened, and/or until the container environment begins getting too warm. The controller can similarly instruct the heating unit to remain on until the container reaches another climate transition point, until the controller determines that the produce have ripened, and/or until the container environment begins getting too warm. The controller can instruct the ripening agent generator to inject the ripening agent into the container and modulate how much of the agent is injected therein based on and until sensed levels of the ripening agent indicate that the ripening process is complete, the controller determines that the produce have ripened, the produce are ripening too slow, and/or the produce are ripening too fast.

The controller can monitor conditions within the container for a ripeness level in 312. As described herein, sensors inside the container can measure levels of the ripening agent inside the container. The sensors can also measure ripeness levels of the produce themselves.

The controller can determine whether a target condition has been reached inside the container in 314. The target condition can be a ripeness level of the produce. The target condition can be based on a distance of the container from the destination location. For example, the target condition can be a refrigerated state to preserve the ripeness and/or freshness of the produce for a remaining duration of travel time to the destination. The target condition can also be a normal environment concentration of gases. The target condition can be determined based on information about the produce, such as how they ripen, their place of origin, their respiration rates, and/or how quickly or slowly they lose ripeness or freshness.

If the target condition has not been reached inside the container, the controller can return to 308, determine what modifications to make to the climate settings of the container, and repeat the blocks 308-314. If the target condition has been reached inside the container, the controller can stop control of the container components in 316. In the example where the ripening agent is released into the container, the controller can instruct the ripening agent generator to deactivate, thereby cutting off a supply of the ripening agent to the container.

The controller can then modify the climate of the container to normal environment conditions in 318. The normal environment conditions, as described herein, can be a refrigerated state. The normal environment conditions can be based on sensed conditions inside the container. The normal environment conditions can also be based on information about the produce. As an example, the controller can instruct components of the container to slowly decrease a temperature of the container to a desired refrigerated temperature of 5° Celsius. The controller can instruct the components to decrease the temperature over a predetermined number of days until the container arrives at the destination. As another example, the container can instruct components to vent the ripening agent out of the container and/or bring in air from outside the container. The controller can also control the components to maintain certain conditions within the container for the remaining duration of the travel time based on sensed conditions.

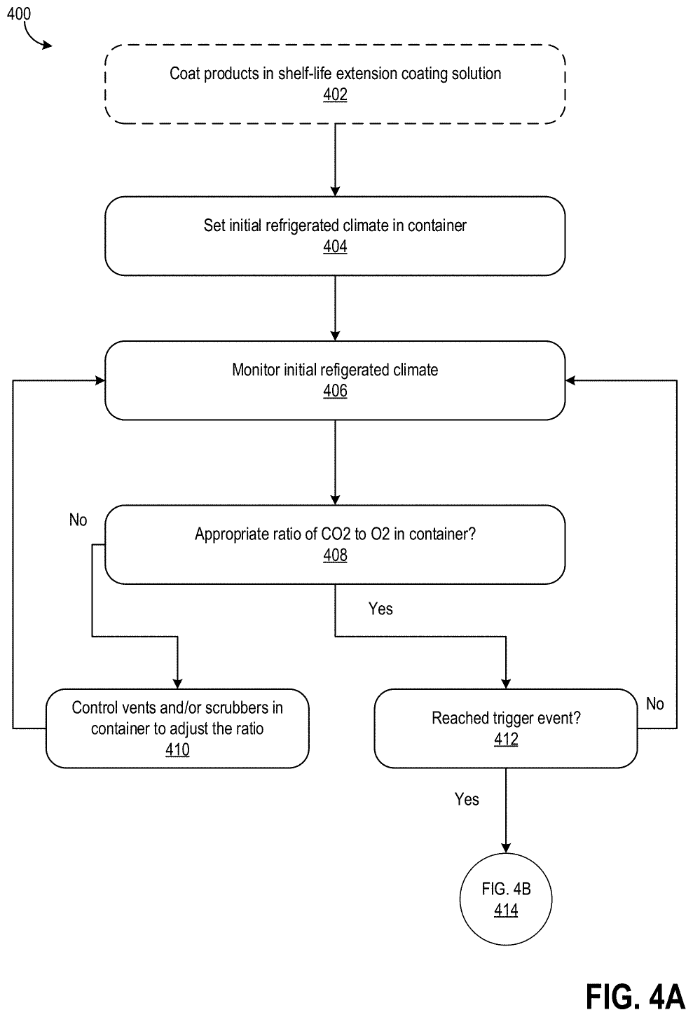

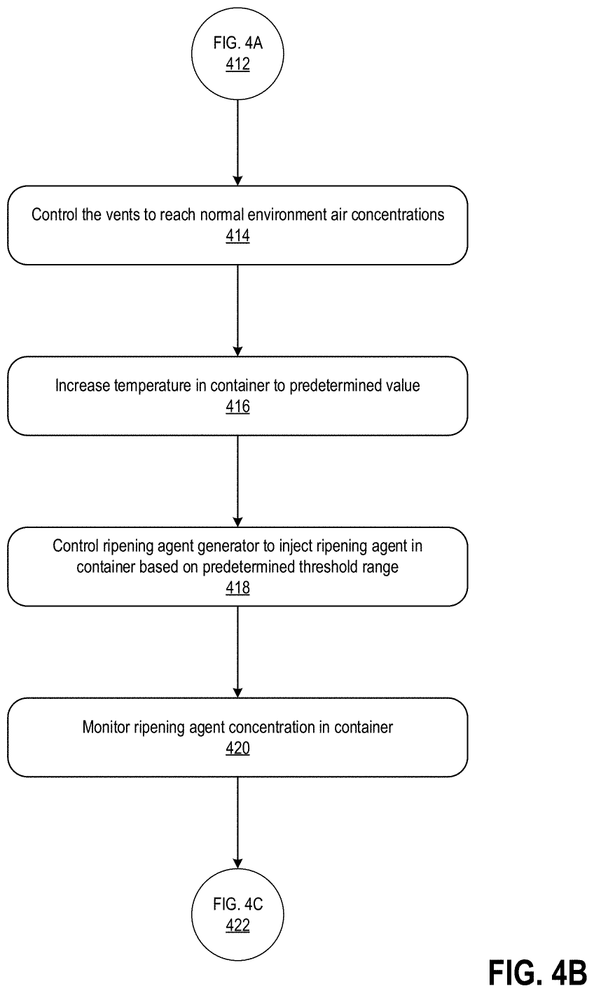

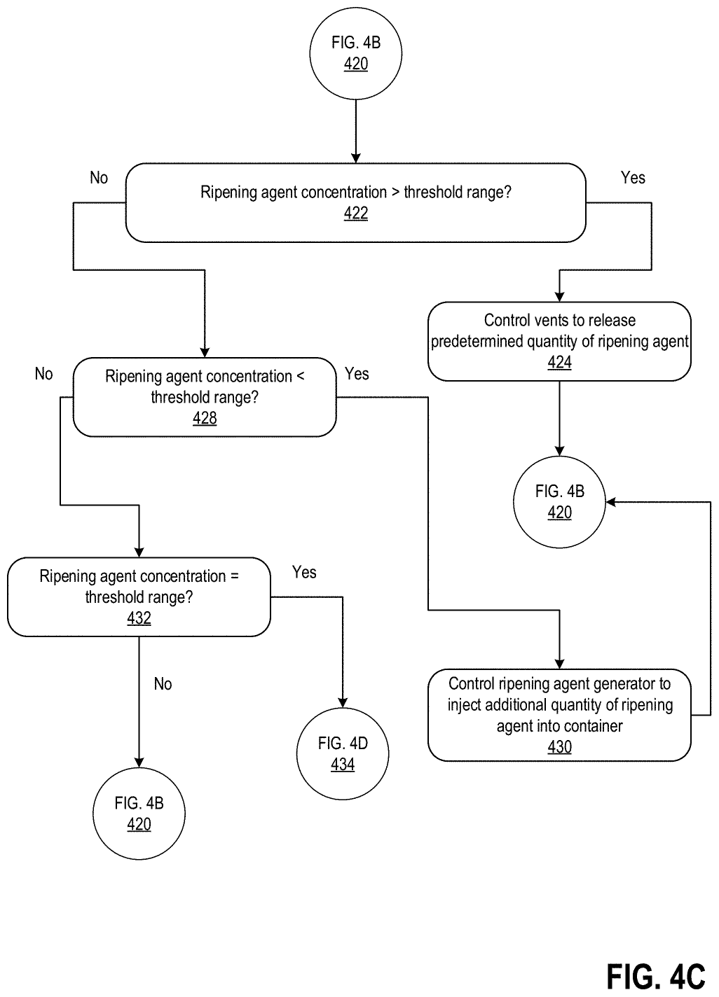

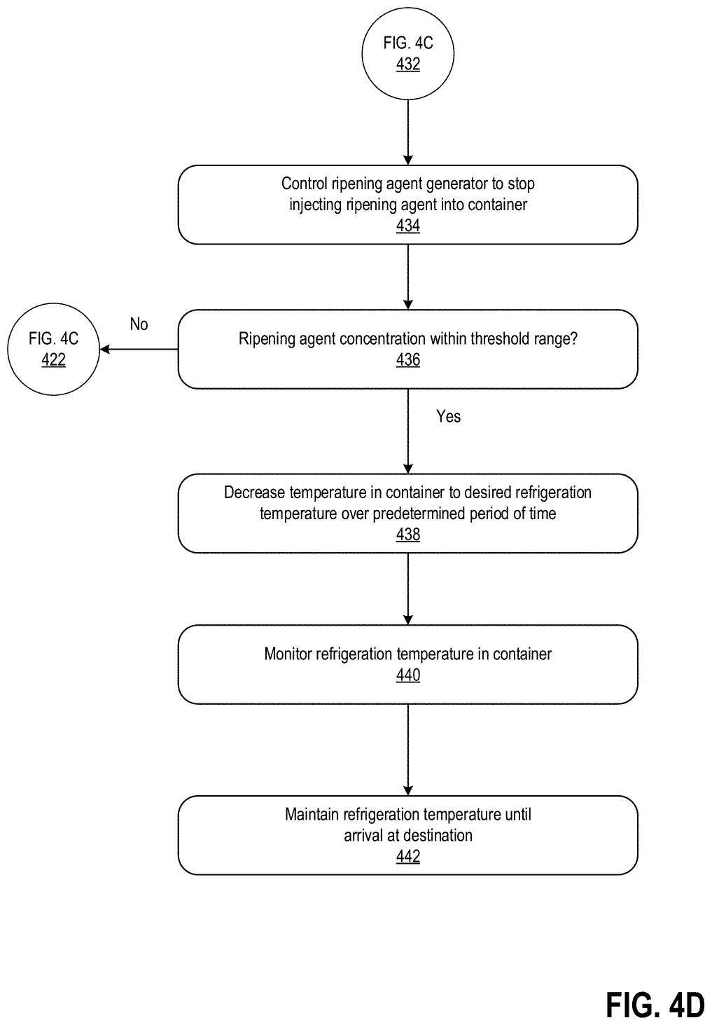

FIGS. 4A-D is a flowchart of a process 400 for modifying a climate of a shipping container with a ripening agent to ripen produce therein. The process 400 can be performed by any one or more of the controllers described herein (e.g., the controller 112 in FIGS. 1A-B, the controller 202 in FIG. 2A, the controller 220 in FIG. 2B). For example, the process 400 can be performed by a controller that is integrated into a shipping container. The process 400 can also be performed by a controller that is part of a self-contained ripening agent unit. In some implementations, one or more blocks in the process 400 can be performed by other computing devices or systems that are integrated in the container and/or separate from the container. For illustrative purposes, the process 400 is described from a perspective of a controller.

Referring to the process 400 in FIGS. 4A-D, the controller can coat produce in a shelf-life extension coating solution in 402. All of the produce in the container can be coated in the shelf-life extension coating solution. Sometimes, some shipment units in the container can be coated in the solution while other shipment units may not. Sometimes, some shipment units in the container can be coated in different concentrations of the solution. An amount of coating solution that is applied to the produce can depend on shipment duration, produce information, and/or customer preferences. Block 402 can be optional. Coating the produce in the shelf-life extension coating solution can be advantageous to maintain freshness of the produce while they are in transit and after transit is complete. Therefore, coating the produce can be advantageous to preserve ripeness and freshness of the produce for longer periods of time.

The controller can set an initial refrigerated climate in the container in 404 (e.g., refer to the process 300 in FIGS. 3A-B). The controller can monitor the initial refrigerated climate of the container in 406 (e.g., refer to the process 300 in FIGS. 3A-B). The controller can determine whether there is an appropriate ratio of CO₂ to O₂ in the container in 408. The appropriate ratio of CO₂ to O₂ can change based on the produce. For example, some produce can require a ratio that is different than a ratio for other produce. The different ratios can be based on information about the produce, such as their places of origin, how quickly or slowly they ripen, how long they can remain fresh, and/or their respiration rates. One or more other factors described throughout this disclosure can also be used to determine the appropriate ratio of gas concentrations.

If the appropriate ratio of CO₂ to O₂ is not met, then the controller can control vents and/or scrubbers in the container to adjust the ratio in 410. For example, if the CO₂ level exceeds a predetermined threshold range for the CO₂, then the controller can activate scrubbers in the container to selectively remove CO₂ from within the container. As another example, if the 02 level is less than a predetermined threshold range for the 02, then the controller can control vents to open such that ambient, external air can enter the container. The predetermined threshold ranges for gas concentrations can depend on a variety of factors, including but not limited to a produce type. As an illustrative example, the predetermined threshold range for CO₂ can be 5%-10% total volume in the container and the predetermined threshold range for O₂ can be 2-5% total volume in the container. In some implementations, the controller may only control scrubbers and not vents. In some implementations, the controller may control only vents and not scrubbers. In yet some implementations, the controller may control both scrubbers and vents. The controller can then return to block 406, continuously monitor the initial refrigerated climate, and repeat blocks 406-408 accordingly.

If the appropriate ratio of CO₂ to O₂ is met in 408, the controller can determine whether a trigger event has been reached in 412. The trigger event can be an indication that the container will be arriving at the destination within a threshold range of time. The threshold range of time can be 3-4 days. The trigger event can also be an indication of how much time remains in transit from a current location of the container. The trigger event can also be an indication of a remaining distance between the current location of the container and the destination. The trigger event, therefore, is reached when arrival to the destination is within some threshold range. Reaching the trigger event indicates that a ripening process can begin.

As an example, it can be desired to begin the ripening process once the container is 3-4 days away from the destination. This desired 3-4 day window can be based on ripening information about the produce and/or conditions sensed inside the container. The controller can receive location information about the container from one or more computing devices in communication with the controller. For example, a container importer can track GPS location information about the container. When the importer determines that the container is within the threshold range, the importer can transmit a notification to the controller of the container indicating that the container is expected to arrive at the destination within 3-4 days. The controller can also receive location information from the importer or other computing devices at predetermined time periods or in real-time.

In some implementations, the controller can be in communication with accelerometers, GPS sensors, or other location sensors configured to the container. The controller can receive sensed values from these sensors to determine whether the container is within the threshold range. In some implementations, the controller can include a timer that starts once the container is put into transit. Once the timer hits predetermined time stops or markers (e.g., 3 days into a 6-day transit), the controller can determine that the container is within the threshold range. In some implementations, the controller can receive or determine updated travel conditions that can cause the threshold range to change. For example, if delays are suddenly expected along the transit route, the controller can determine that the threshold range can be pushed forward or back a predetermined amount of time.

If the arrival is not within the threshold range, the controller can return to block 406 and repeat blocks 406-412. If the arrival is within the threshold range, then the controller can control the vents to reach normal environment air concentrations in 414. It can be preferred to perform the ripening process while the container environment experiences normal air concentrations. The normal air concentrations can be different based on the produce and/or sensed conditions inside the container. In some implementations, the controller can also control one or more other components in the container (e.g., a refrigeration unit, heating unit, fans, CO₂ scrubber, etc.) to reach the normal environment air concentrations, as described herein.

The controller can cause components of the container to increase a temperature in the container to a predetermined value in 416. It can be preferred to perform the ripening process at a temperature that is warmer than the refrigerated climate. In some examples, a desired temperature for the ripening process can be 18° Celsius. The desired temperature can range anywhere between 18° Celsius and 22° Celsius. The desired temperature can change based on sensed conditions and/or information about the produce. For example, some produce may ripen at different temperatures and/or humidity levels compared to other produce.

The controller can control a ripening agent generator to inject a ripening agent, such as ethylene gas, into the container based on a predetermined threshold range in 418. The generator may not be actuated until the desired temperature is reached inside the container. In some implementations, the generator can be actuated to begin injecting the ripening agent into the container while the temperature is being increased inside the container. In such an example, while the temperature is being increased, a smaller concentration of ripening agent can be injected into the container. Once the desired temperature is reached, a larger concentration of ripening agent can be injected into the container.

The predetermined threshold range for injecting the ripening agent into the container can be based on numerous factors. The amount of ripening agent to inject in the container can depend on how much time the container will remain in transit before arriving at the destination location. For example, if warming the container takes a longer amount of time than originally projected, a greater quantity of ethylene can be injected into the container in order to ensure that the produce are ripened before arrival at the destination. As another example, if the produce ripen at a rate that is faster than the amount of time remaining in transit, then a smaller quantity of ethylene can be injected in the container such that the ripening process takes longer. Doing this can be advantageous to ensure that the produce are ripe and fresh upon arrival at the destination location. If the produce are quickly ripened several days before arrival at the destination, the produce may lose some of their freshness by the time they arrive at the destination.

The amount of ripening agent to inject in the container can also depend on ripening information about the produce. For example, if the produce ripens quickly, a smaller amount of ripening agent can be injected into the container so as to not over-ripen the produce. As another example, once receptors of the produce are saturated with the ripening agent, temperature modifications can be made in the container to continue the ripening process for the produce. Temperature in the container can be continuously and gradually increased to improve a ripening rate of the produce once the produce are saturated with the ripening process and the ripening agent is no longer being injected into the container. Moreover, the amount of ethylene to inject in the container can depend on whether the produce was coated in the shelf-life extension coating solution in 402.

Still referring to the process 400, the controller can monitor a ripening agent concentration inside the container in 420. Monitoring the concentration can include receiving indications from sensors within the container. The indications can include sensed levels of the ripening agent in different regions or areas of the container. The indications can also include sensed ripeness levels of the produce in the container.

The controller can determine whether the ripening agent concentration exceeds a threshold range in 422. The threshold range can be determined by the controller and based on the sensed conditions. The threshold range can also be based on ripening information about the produce and other information about the produce, as described throughout this disclosure. For example, the threshold range can indicate a range in which the produce are considered ripe and ready for purchase by consumers and/or a particular customer. The threshold range can also indicate a range in which the produce are considered ripe enough such that once the produce arrive at the destination location, the produce can continue to ripen. In some implementations, ripening agent concentrations can be different in one or more regions or areas of the container. For example, a first corner of the container can have a low concentration of the ripening agent while a second corner of the container can have a high concentration of the ripening agent. In some implementations, the first and second corners can be required to have different ripening agent concentrations, for example, based on the types of produce located therein. In other implementations, the first and second corners can be required to have the same ripening agent concentrations (e.g., the entire container can be required to have a uniform ripening agent concentration). The controller can determine whether each corner, region, or area of the container has the desired range of ripening agent concentration. The controller can also determine an aggregate ripening agent concentration for the container based on the levels of each corner, region, or area of the container.

If the ripening agent concentration exceeds the threshold range, the controller can control vents to release a predetermined quantity of ripening agent from the container in 424. The controller can then return to block 420. The controller can also control one or more other components to adjust the concentration of the ripening agent in the container, as described herein. For example, the controller can instruct the ripening agent generator to turn off for a predetermined amount of time. The controller can also instruct one or more fans to turn on, thereby spreading or dispersing the ripening agent towards corners or regions of the container where there are lower ripening agent concentrations.

The predetermined quantity of ripening agent to release from the container can be based on a ratio of how much the determined ripening agent concentration in the container exceeds the threshold range. The predetermined quantity can also be based on an amount of time remaining in transit. The predetermined quantity can also be based on ripening information or current, sensed ripening conditions of the produce. In some implementations, the controller can instruct the vents to open until the sensors inside the container sense a ripening agent concentration that is within the threshold range.

If the ripening agent concentration does not exceed the threshold range in 422, the controller can determine whether the ripening agent concentration is less than the threshold range in 428. If the concentration is less than the threshold range, the controller can control the generator to inject an additional quantity of the ripening agent into the container in 430. The controller can then return to block 420. As described above, the controller can also control one or more other components in the container to facilitate the spread of the ripening agent within the container and/or the concentration of the ripening agent in different corners or regions of the container.

If the concentration is not less than the threshold range, the controller can determine whether the concentration is within the threshold range in 432. If the concentration is not within the threshold range, then the controller can return to block 420. If the concentration is within the threshold range, then the controller can control the generator to stop injecting the ripening agent into the container in 434. The controller can determine whether the ripening agent concentration is within the threshold range in 436. If the concentration is within the threshold range, then the current ripening agent concentration can be monitored and maintained for a period of time, such as 24-48 hours, to achieve optimal ripeness. Once the period of time of maintaining the concentration is complete, the controller can decrease the temperature in the container in 438, as described below. If the concentration is not within the threshold range in 436, then the controller can return to block 422 to adjust the ripening agent concentration until it reaches and remains within the predetermined range for the period of time. The threshold range can vary depending on a produce category. For example, climacteric produce, such as avocados, mangos, and bananas, may have a threshold range of 100-200 ppm. As another example, citrus fruits, such as oranges and limes, may have a threshold range of 1-10 ppm. Moreover, the period of time, such as 24-48 hours, and/or the threshold range can depend on seasonality, geography, and/or customer preferences/specifications about how ripe they want the produce to be upon arrival. As an illustrative example, earlier season produce may require more ripening agent (e.g., a higher ripening agent concentration) and/or longer exposure (e.g., 48 hours instead of 24 hours) to the ripening agent than a later season produce for the earlier season produce to achieve the same ripeness level as the later season produce.

In some implementations in 434, the controller can also instruct other components in the container to stop the ripening process temporarily such that the ripening agent concentration remains within the predetermined range for the period of time. For example, the controller can instruct vents to open such that the ripening agent can be removed from the container and released into an external environment. The controller can also instruct fans to actuate to assist in directing the ripening agent out of the container and through the vent outlets.

The controller can decrease the temperature in the container to a desired refrigeration temperature over a predetermined period of time in 438. The desired refrigeration temperature can have a normal gas composition, such as 20% O₂ and 400 ppm CO₂. As mentioned, the controller can instruct the refrigeration unit to blow cold air into the container, thereby reducing the temperature. It can be preferred to reduce the temperature to the desired refrigerated state to preserve the ripeness and freshness of the produce. The predetermined period of time can be less than an amount of remaining time in transit. For example, the temperature of the container can be reduced to the refrigerated state within 1 day, and during a remaining day in transit, the refrigerated state can be maintained. The predetermined period of time can also be equal to the amount of remaining time in transit. For example, for the remaining amount of time in transit, the temperature of the container can be slowly decreased. Therefore, the container can reach the desired refrigerated temperature (e.g., 0° Celsius to 5° Celsius) upon arrival at the destination.

The controller can monitor the refrigeration temperature in the container in 440. Based on sensed conditions in the container, the controller can determine whether the temperature of the container is reaching or has reached the desired refrigeration temperature.

The controller can maintain the temperature in the container at the desired refrigeration temperature until arrival at the destination in 442. Based on 440, the controller may determine that the temperature of the container should be lowered faster such that the produce can remain refrigerated for a longer period of time before arriving at the destination. The controller may also determine that once the refrigeration unit stops cooling the container, the temperature of the container begins to rise, so the refrigeration unit can be actuated again. Maintaining the temperature in the container can also include turning on fans to ensure that the colder temperature air is evenly distributed and/or circulated throughout the container.

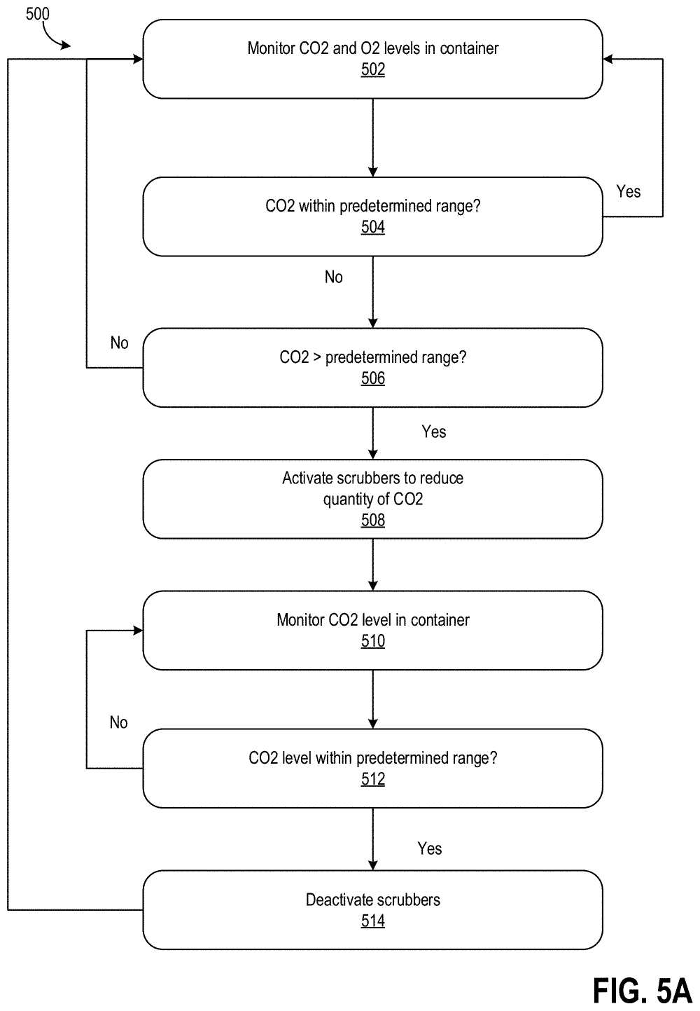

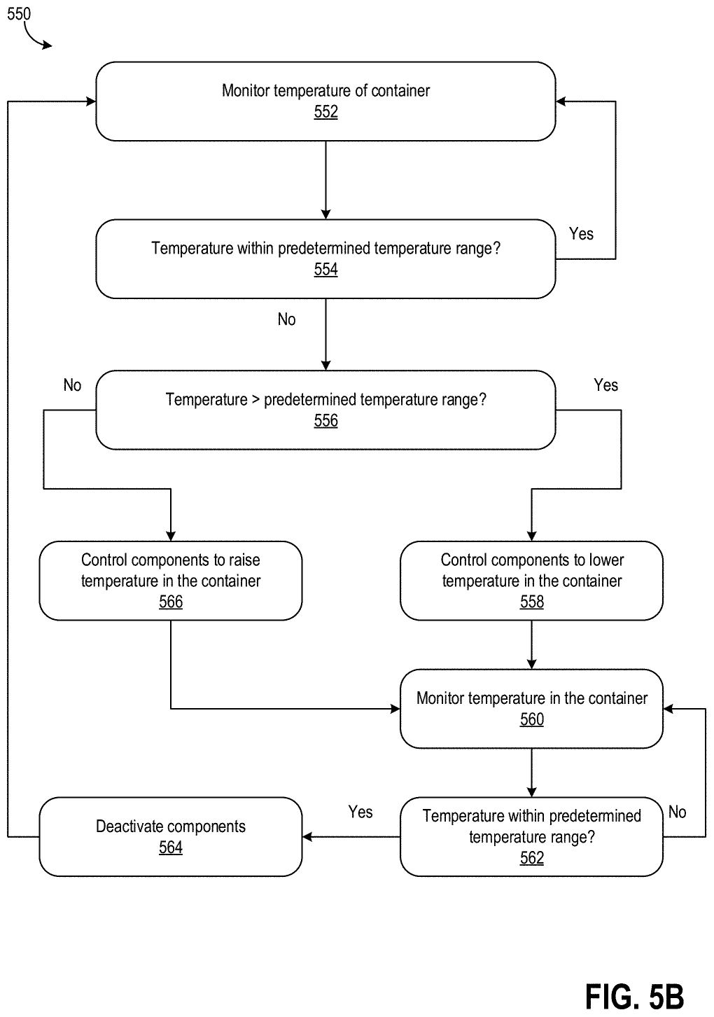

FIGS. 5A-B are flowcharts of processes 500 and 550 for setting an initial climate of the shipping container. The process 500 in FIG. 5A can be performed to set gas concentration levels in the shipping container. The process 550 in FIG. 5B can be performed to set a temperature in the shipping container. The processes 500 and 550 can be performed simultaneously (e.g., at the same time) in order to set the initial climate of the shipping container. In some implementations, the processes 500 and 550 can be performed sequentially. For example, the process 500 can be performed first and once the desired gas concentration levels are reached, the process 550 can be performed to reach the desired temperature in the shipping container. As another example, the process 550 can be performed first followed by the process 500. In yet some implementations, only one of the processes 500 and 550 may be performed. The processes 500 and 550 can be performed by any one or more of the controllers described herein (e.g., the controller 112 in FIGS. 1A-B, the controller 202 in FIG. 2A, the controller 220 in FIG. 2B). For example, the processes 500 and 550 can be performed by a controller that is integrated into a shipping container. The processes 500 and 550 can also be performed by a controller that is part of a self-contained ripening agent unit. In some implementations, one or more blocks in the processes 500 and 550 can be performed by other computing devices or systems that are integrated in the container and/or separate from the container. For illustrative purposes, the processes 500 and 550 are described from a perspective of a controller.

Referring to the process 500 depicted in FIG. 5A, the controller can monitor CO₂ and O₂ levels inside the container in 502 (e.g., refer to the processes 300 and 400 described above). Monitoring the levels can include receiving sensed CO₂ and O₂ concentrations from sensors positioned throughout the container. The controller can determine whether the sensed CO₂ is within a predetermined range in 504. The predetermined range can be determined based on the type of produce in the container, produce information, or other information associated with the ripening process, as described throughout this disclosure.

If the CO₂ is within the predetermined range, then the controller can return to block 502, and continuously monitor the gas concentration levels in the container. Thus, the controller can monitor the CO₂ and O₂ levels in the container to ensure that these levels remain within the predetermined range. If the CO₂ is not within the predetermined range in 504, the controller can determine whether the CO₂ level exceeds the predetermined range in 506. If the CO₂ exceeds the predetermined range, then the produce may be producing too much CO₂. Thus, the controller can activate scrubbers in the container to reduce a quantity of CO₂ from the container in 508. The controller then can monitor the CO₂ level in the container in 510 to determine whether the CO₂ level lowers to the predetermined range.

In 512, if the CO₂ level lowers to be within the predetermined range, the controller can deactivate the scrubbers in 514. Once the scrubbers are deactivated, the controller can return to block 502 and continuously monitor the CO₂ and O₂ levels in the container to ensure they remain within the predetermined range. If the CO₂ level has not yet lowered to be within the predetermined range (512), then the controller can return to block 510 and continuously monitor the CO₂ level in the container until it falls within the predetermined range.

Referring back to 506, if the CO₂ level does not exceed the predetermined range, then the controller can return to block 502 to continuously monitor gas concentration levels in the container. If the CO₂ level is less than the predetermined range, then the produce may not be producing enough CO₂. This may result from an O₂ deficit in the container. The produce may need more time to produce enough CO₂ to reach the desired predetermined range. Thus, the controller may not do anything other than monitor the gas concentration levels in the container until the produce produces enough CO₂ to fall within the predetermined range.

Referring to the process 550 depicted in FIG. 5B, the controller can monitor a temperature of the container in 552. The controller can determine whether the temperature of the container falls within a predetermined temperature range in 554. The predetermined temperature range can depend on a variety of factors, including but not limited to produce information, ripening conditions, geographic conditions, place of origin, transit conditions and duration, and/or customer preferences/specifications. As described in reference to the process 400 in FIGS. 4A-D, the controller can monitor temperatures for different regions or areas of the container. The controller can then determine an aggregate temperature for the container. The controller can also determine whether each region or area of the container has a temperature value that is within a predetermined range for that region or area of for the overall container as a whole.

If the temperature of the container is within the predetermined temperature range in 554, then the controller returns to block 552 and continues to monitor the temperature of the container. After all, no change may need to be made to the container's environment so long as the temperature is within the desired range. If, on the other hand, the temperature does not fall within the predetermined temperature range in 554, then the controller can determine whether the temperature of the container exceeds the predetermined temperature range in 556.

If the temperature of the container exceeds the predetermined range, then the controller can control components of the container to lower the temperature in the container in 558 (e.g., refer to the processes 300 and 400). The controller then continues to monitor the temperature in the container in 560. The controller can determine whether the temperature has lowered enough to fall within the predetermined temperature range in 562. If the temperature is still not within the predetermined temperature range, the controller returns to block 560 and continuously monitors the temperature until the desired range is reached. If, on the other hand, the temperature has lowered to fall within the predetermined temperature range in 562, the controller can deactivate components that were previously controlled to lower the temperature (564). For example, the controller can turn off a refrigeration unit or other cooling units or elements that were activated by the controller in 558. Then, the controller can return to block 552 and continuously monitor the temperature of the container such that the temperature remains within the predetermined temperature range.

Referring back to block 556, if the temperature is less than the predetermined temperature range, then the controller can control components of the container to raise the temperature in the container in 566 (e.g., refer to the processes 300 and 400). The controller can then proceed to block 560 and monitor the temperature in the container until it raises to fall within the predetermined temperature range. If the temperature has not yet increased to the predetermined temperature range (562), the controller continuously monitors the temperature in the container. If the temperature has increased enough to fall within the predetermined temperature range (562), then the controller can deactivate components (e.g., a heating unit) that were activated to raise the temperature in the container (564). The controller then returns to block 552 and repeats the process 550 to maintain the temperature of the container within the desired predetermined temperature range. When the temperature of the container is within the predetermined temperature range, the container environment can be set and ready for the ripening process to begin.

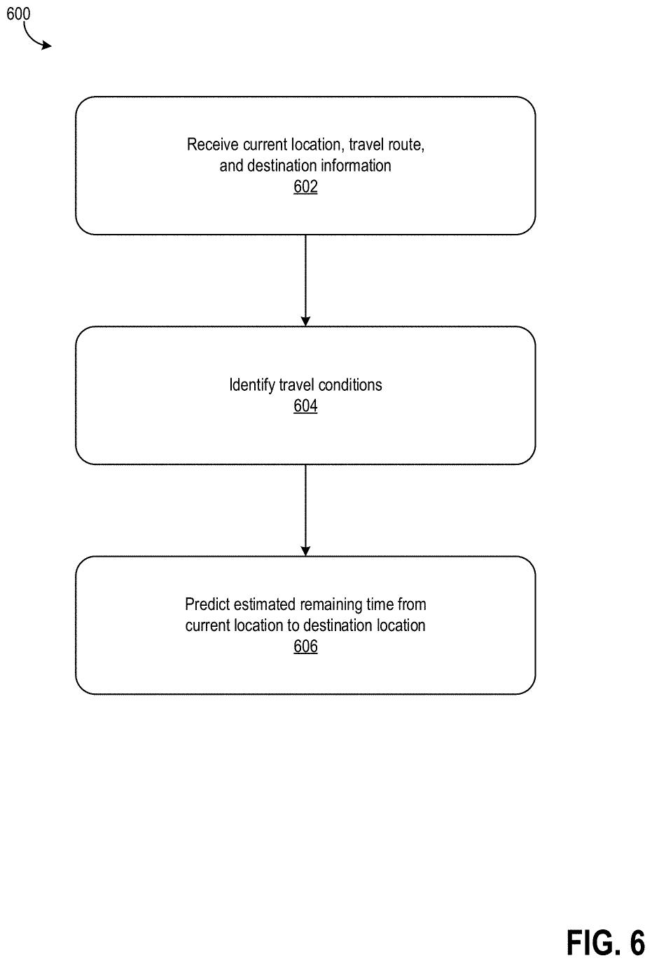

FIG. 6 is a flowchart of a process 600 for determining arrival at a destination location. The process 600 can be performed by any one or more of the controllers described herein (e.g., the controller 112 in FIGS. 1A-B, the controller 202 in FIG. 2A, the controller 220 in FIG. 2B). For example, the process 600 can be performed by a controller that is integrated into a shipping container. The process 600 can also be performed by a controller that is part of a self-contained ripening agent unit. In some implementations, one or more blocks in the process 600 can be performed by other computing devices or systems that are integrated in the container and/or separate from the container. For illustrative purposes, the process 600 is described from a perspective of a controller.

Referring to the process 600 in FIG. 6, the controller can receive current location, travel route, and destination information in 602. As described throughout this disclosure, this information can be received from a computing device in communication with the controller (e.g., a computing system of a product importer). This information can also be received from sensors (e.g., location, weather, GPS, etc.) in communication with the controller. This information can be received in real-time. This information can also be received at predetermined time intervals or points along the transit route. In some implementations, one or more of this information may only be received when an unexpected event or condition is identified by the controller or another computing device in communication with the controller. For example, an importer may identify a storm that can delay arrival of the container at its destination. The importer's computing system can communicate information about the storm to the controller. The controller can then use such information to make adjustments to climate modification events for the container.

The information can include container tracking updates. The tracking updates can be location-based. The tracking updates can be based on an estimated time of arrival. The tracking updates can also be based on how long a timer or clock has been running since the container left its starting location.

The controller can identify travel conditions in 604. The travel conditions can include traffic along a route (e.g., where the container is transported over roads). The travel conditions can also include delays from a holdup at customs of a port (e.g., where the container is transported overseas). The travel conditions can also include delays based on predicted, forecasted, or current weather patterns. The travel conditions can include other types of delays that may be unexpected while in transit. For example, components of the container may need to be replaced during transit. The container may be stopped at additional locations along the transit route to pick up or drop off one or more produce. Other travel conditions can also be determined from the information received in 602.

The controller can predict an estimated remaining time from the current location of the container to the destination location in 606. The controller can make this prediction based on the travel conditions that are determined in 604. The controller can, for example, determine when the container was originally supposed to arrive at the destination location and then determine when the container is now projected to arrive at the destination location. The delta between the original and projected arrival times can indicate how much longer the container will be in transit. Based on the delta, the controller can determine how to adjust climate modification events for the container, as described herein.

As an example, assuming the delta is 3 days, the controller can determine that the ripening process should be delayed by 3 days. Therefore, the controller can instruct components of the container to maintain a refrigerated, controlled atmosphere state for another 3 days rather than modifying the climate to normal air concentrations and beginning the ripening process as originally scheduled.

As another example, the controller can instruct components of the container to perform the ripening process more slowly if the ripening process has already begun and the projected arrival is later than the originally scheduled arrival. For example, the controller can instruct components to perform the ripening process at 16° C. instead of at 18° C. The controller can also instruct components of the container to perform the ripening process faster if the ripening process has already begun and the projected arrival is earlier than the originally scheduled arrival.

Using the process 600, the controller can more accurately time and/or schedule modifications to the container environment to ensure that produce contained therein are ripened in time for arrival at the destination location. The process 600 can also be advantageous to ensure that the produce remain fresh while in transit before arriving at the destination location.

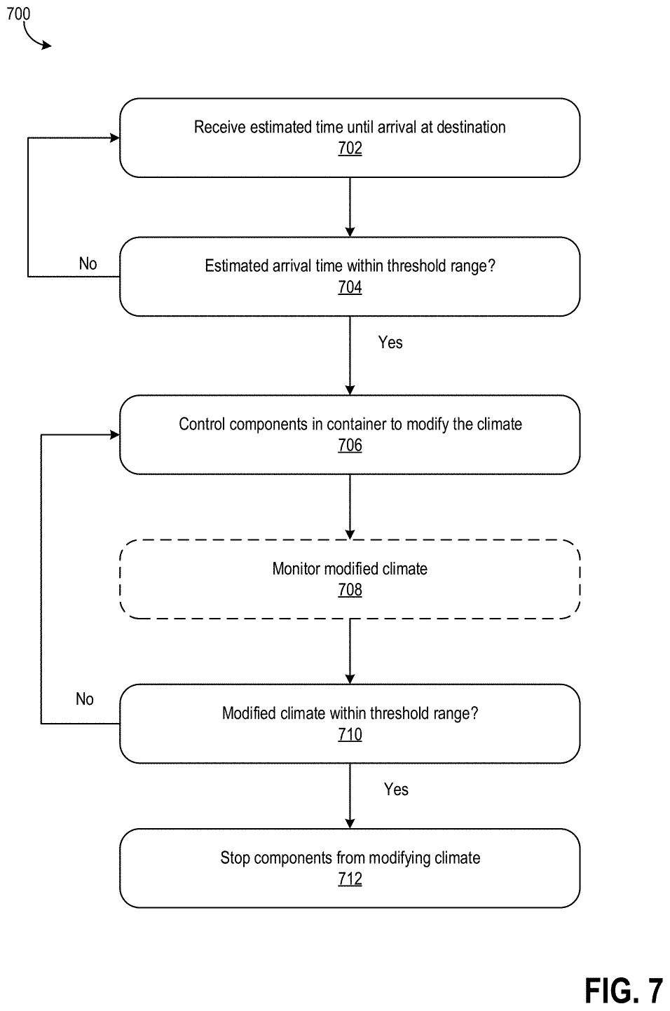

FIG. 7 is a flowchart of a process 700 for modifying a climate of the shipping container based on remaining time in transit to the destination location. The process 700 can be performed by any one or more of the controllers described herein (e.g., the controller 112 in FIGS. 1A-B, the controller 202 in FIG. 2A, the controller 220 in FIG. 2B). For example, the process 700 can be performed by a controller that is integrated into a shipping container. The process 700 can also be performed by a controller that is part of a self-contained ripening agent unit. In some implementations, one or more blocks in the process 700 can be performed by other computing devices or systems that are integrated in the container and/or separate from the container. For illustrative purposes, the process 700 is described from a perspective of a controller.

Referring to the process 700 in FIG. 7, the controller can receive an estimated time until arrival at a destination in 702 (e.g., refer to the processes 300, 400, 500, and 600). The estimated time can be determined by the controller (e.g., refer to the process 600 in FIG. 6). The estimated time can also be received from other computing devices or systems, such as an importer computing device (e.g., refer to the process 600 in FIG. 6).

The controller can determine whether the estimated arrival time is within a threshold range in 704. The threshold range can be determined based on information about how quickly or slowly the product ripens. The threshold range can also be based on how long overall transit can be for the product from start location to destination location. The threshold range can be the same for one or more containers. The threshold range can be different for one or more containers and based on different factors or conditions as described above. In some implementations, the threshold range can be 3 days. Therefore, if the container is expected to arrive at the destination location within 3 days, then a ripening process can begin or one or more other modifications can be made to the climate.

If the estimated arrival time is not within the threshold range, then the controller can return to block 702. In other words, it can be too early during transit to begin the ripening process or perform other modifications to the container climate. If the estimated arrival time is within the threshold range, the controller can control components in the container to modify the climate therein in 706. In other words, it can be a right time to begin the ripening process and/or performing any other modifications to the climate of the container.

The controller can optionally monitor the modified climate in 708. As described herein (e.g., refer to the process 300, 400, 500, and 600), the controller can receive sensed values from sensors positioned within the container. Based on those sensed values, the controller can determine whether the climate is being modified to predetermined and/or desired settings.

The controller can determine whether the modified climate is within a threshold range in 710. The threshold range can be different for each container based on product information and/or sensed conditions inside the container. The threshold range can also be different based on how much time remains in transit between a current location of the container and the destination location. In some implementations, the threshold range can be a refrigerated state range. In some implementations, the threshold range can be a normal air concentrations state range. In some implementations, the threshold range can also be a ripening process state range. Moreover, in some implementations, the threshold range can be smaller where there is less remaining time in transit between the current location and the destination location. The smaller threshold range can indicate that there is less time to modify the climate to the desired threshold range. In other implementations, the threshold range can be larger where there is more remaining time in transit between the current location and the destination location. The larger threshold range can indicate that there is more time to modify the climate to the desired threshold range.

If the climate is within the threshold range, the controller can stop components of the container from modifying the climate in 712. This can indicate that the desired climate settings have been reached (e.g., the climate of the container has been modified to a refrigerated state, a normal air concentration state, a ripening process state, a ripened state, etc.). Therefore, the climate of the container no longer needs to be modified. The controller can, for example, turn off components such as a refrigeration unit, heating unit, ripening agent generator, fans, and/or vents.

In some implementations, block 712 can be performed at a same or similar time as arrival at the destination location. Therefore, the climate of the container can be modified for a remaining duration of transit between the current location of the container and the destination location. In some implementations, block 712 can be performed some time before arrival at the destination location. In such examples, the controller can optionally continue to monitor the container's climate to ensure the climate remains within the threshold range until arrival at the destination location.

If the climate is not within the threshold range, then controller can return to block 706. This can indicate that the threshold range has not yet been achieved. The climate of the container can continue to be modified. The blocks 706-710 can be repeated until the modified climate is within the threshold range and/or the container arrives at the destination location.

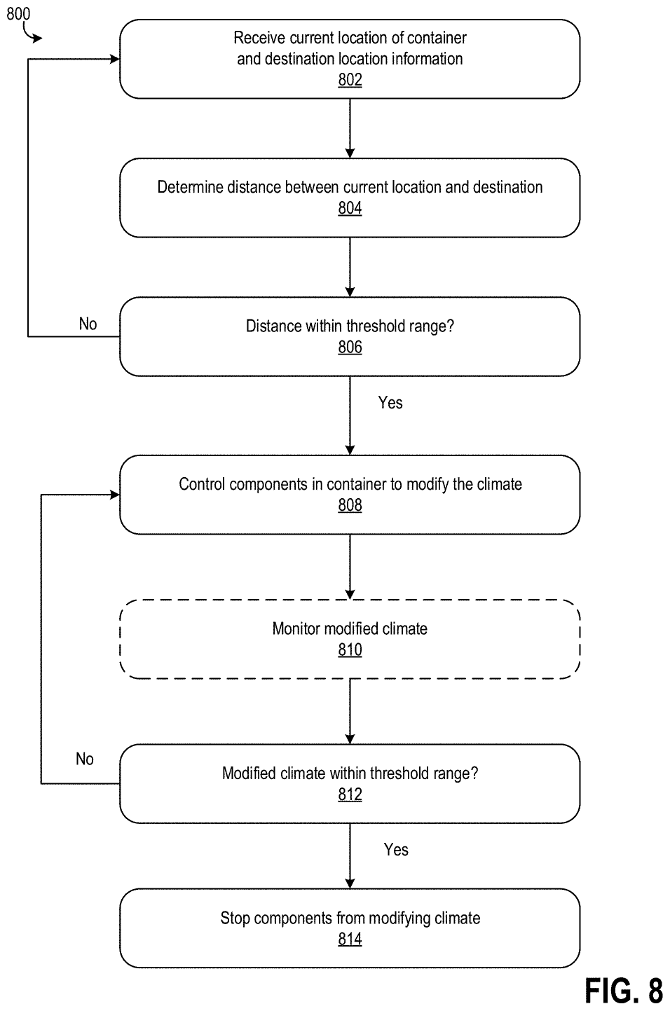

FIG. 8 is a flowchart of a process 800 for modifying a climate of the shipping container based on a remaining distance from the destination location. The process 800 can be performed by any one or more of the controllers described herein (e.g., the controller 112 in FIGS. 1A-B, the controller 202 in FIG. 2A, the controller 220 in FIG. 2B). For example, the process 800 can be performed by a controller that is integrated into a shipping container. The process 800 can also be performed by a controller that is part of a self-contained ripening agent unit. In some implementations, one or more blocks in the process 800 can be performed by other computing devices or systems that are integrated in the container and/or separate from the container. For illustrative purposes, the process 800 is described from a perspective of a controller.

Referring to the process 800 in FIG. 8, the controller can receive a current location of the container and destination location information in 802. As described throughout, the current location and destination location information can be received from sensors (e.g., accelerometers, GPS, location-based, etc.) in communication with the controller. This information can also be received from other computing devices or systems that are in communication with the controller (e.g., computing device of an importer). The received current location information can be updated in real-time as the container moves along its transit route to the destination location.

The controller can determine a distance between the current location and the destination in 804. In some implementations, the controller can determine the distance every time that the controller receives an updated current location of the container. The controller can also determine the distance at predetermined times. In some implementations, another computing device (e.g., the computing device of the importer) can determine the distance between the current location and the destination and transmit the distance to the controller.

The controller can then determine whether the distance is within a threshold range in 806. The threshold range can be determined based on numerous factors, as described in reference to the estimated arrival time threshold range in the process 700 (e.g., refer to block 704 in FIG. 7). If the distance is not within the threshold range, the controller can return to 802 and receive current location information of the container. This can indicate that the container is too far away from the destination location to begin modifying the container's climate or beginning a ripening process. After all, starting the ripening process too early can cause one or more of the produce to no longer be as fresh and/or ripe by the time they arrive at the destination location. The ripening process and/or other modifications to the container climate should begin when the distance is within the threshold range. Therefore, blocks 802-806 can be repeated until the distance is within the threshold range.

If the distance is within the threshold range in 806, then the controller can control components in the container to modify the climate in 808. When the distance is within the threshold range, a climate modification process and/or the ripening process can begin. This can indicate that an ideal or preferred amount of time remains to complete the climate modifications and/or the ripening process before arrival at the destination location. Beginning the ripening process at this point in time, for example, can result in the produce being fresh and ripe at the time of arrival at the destination location.

The controller can optionally monitor the modified climate in 810, as described above in reference to the processes 300, 400, 500, 600, and 700. The controller can determine whether the modified climate is within a threshold range in 812 (e.g., refer to the processes 300, 400, 500, 600, and 700). If the climate is not within the threshold range, then the controller can return to 808 and control components in the container to modify the climate. This can indicate that desired climate settings and/or ripening has not yet been reached. Blocks 808-812 can be repeated until the modified climate is within the threshold range.

If the climate is within the threshold range in 812, then the controller can stop the components from further modifying the climate in 814 (e.g., refer to the processes 300, 400, 500, 600, and 700). This can indicate that the desired climate settings and/or ripening has been reached. As described in reference to the process 700 in FIG. 7, block 814 can be performed at a time of arrival at the destination location. Block 814 can also be performed before arrival at the destination location, based on the desired climate settings and/or ripening being reached. In such examples, the controller can continue to monitor the container's climate and ensure that the desired climate settings and/or ripening are maintained until arrival at the destination location.

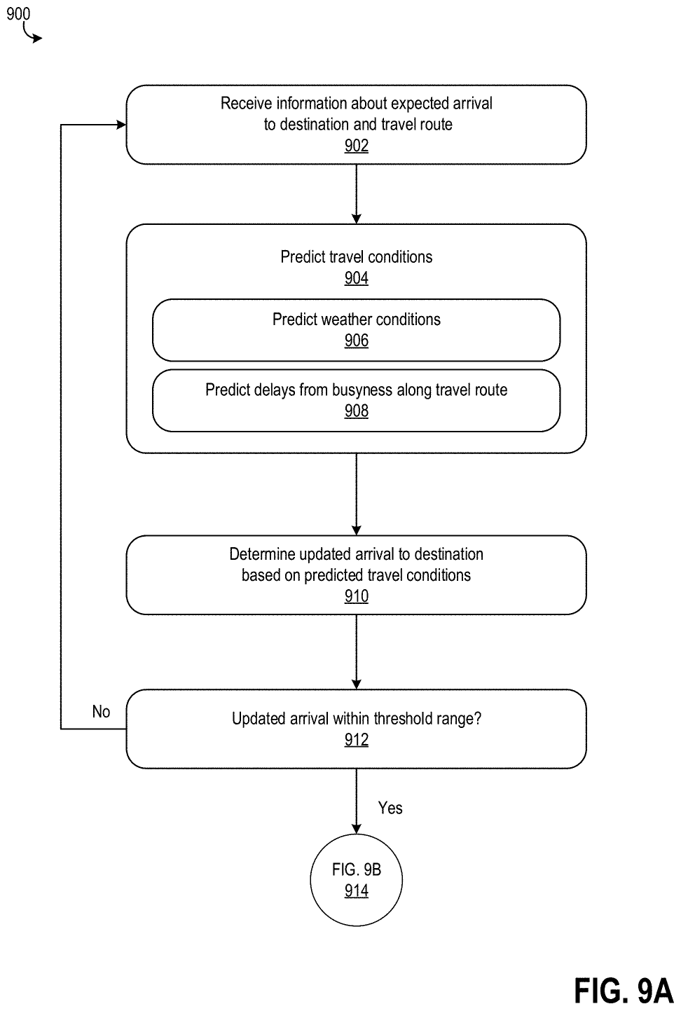

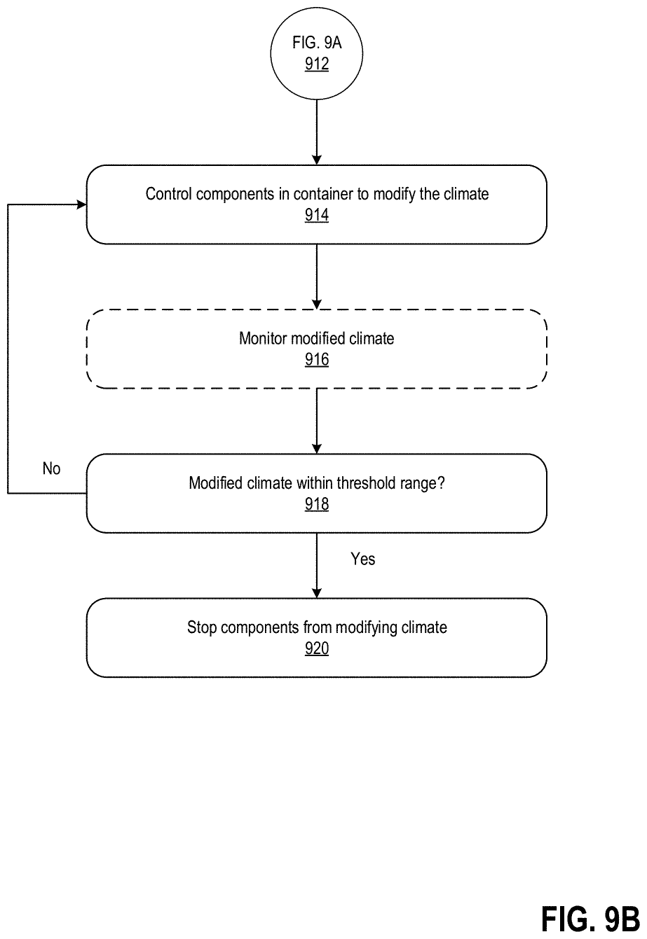

FIGS. 9A-B is a flowchart of a process 900 for modifying a climate of the shipping container based on predicted travel conditions. The process 900 can be performed by any one or more of the controllers described herein (e.g., the controller 112 in FIGS. 1A-B, the controller 202 in FIG. 2A, the controller 220 in FIG. 2B). For example, the process 900 can be performed by a controller that is integrated into a shipping container. The process 900 can also be performed by a controller that is part of a self-contained ripening agent unit. In some implementations, one or more blocks in the process 900 can be performed by other computing devices or systems that are integrated in the container and/or separate from the container.

Referring to the process 900 in both FIGS. 9A-B, the controller can receive information about an expected arrival to a destination location and a travel route in 902. As described throughout (e.g., refer to FIGS. 7-8), the information about the expected arrival can include time and/or distance information. The information can be received from a computing device or system in communication with the controller, such as a computing device of an importer. For illustrative purposes, the process 900 is described from a perspective of a controller.

Using the information received in 902, the controller can predict travel conditions in 904. For example, the controller can predict weather conditions along the travel route (906). The controller can also predict delays from busyness along the travel route (908). Predicting the travel conditions can also be performed by the other computing device or system in communication with the controller. The controller can predict travel conditions at predetermined times while the container is in transit to the destination location. In some examples, the controller can predict travel conditions in real-time whenever the controller receives information in 902. In yet other implementations, the controller can predict travel conditions upon receiving a notification from the other computing device that there are unanticipated delays along the travel route.

The controller can then determine an updated arrival to the destination location based on the predicted travel conditions in 910. In some implementations, the updated arrival can be less than or shorter than an original estimated arrival. In other implementations, the updated arrival can be more than or longer than the original estimated arrival. The updated arrival can be in terms of time and/or distance. The controller can optionally transmit the updated arrival to the other computing device and/or additional computing devices and/or systems in communication with the controller.

The controller can determine whether the updated arrival is within a threshold range in 912. As described herein, the threshold range can be based on a number of factors or conditions, such as ripening or other information associated with produce in the container and/or sensed container climate conditions. The threshold range can indicate a window of time in which modifications can be made to the climate of the container.

If the updated arrival is not within the threshold range, then 902-912 can be repeated until the updated arrival is within the threshold range. If the updated arrival is within the threshold range, then the controller can control components in the container to modify the climate in 914. As described throughout this disclosure, modifying the climate in 914 can include injected a ripening agent (e.g., ethylene gas) into the environment of the container. Modifying the climate can also include increasing a temperature inside the climate to normal air concentrations that are preferred for the ripening process.

The controller can optionally monitor the modified climate in 916. As described herein, monitoring the climate can include receiving indications of temperature, ripeness level(s), humidity, and other conditions from sensors positioned inside the container. Based on the received indications, the controller can make adjustments to the modified climate to maintain the climate within a desired range. Therefore, the controller can determine whether the modified climate is within a threshold range in 918. The threshold range can be associated with ripeness levels. For example, if the climate is within the threshold range, this can indicate that the produce are ripe. In some implementations, the threshold range can also be based on remaining time or distance to the destination, ripening product information, and/or product place of origin.

If the climate is not within the threshold range, 914-918 can be repeated until the climate is within the threshold range. In other words, the ripening process can continue until the produce inside the container have ripened.

If the climate is within the threshold range, then the controller can stop components in the container from modifying the climate in 920. In other words, the ripening process is complete and the produce in the container are ripe. Stopping components from modifying the climate can include, as describe throughout this disclosure, turning off injection of a ripening agent in the container and/or opening vents in the container to air out any remaining ripening agent in the container.

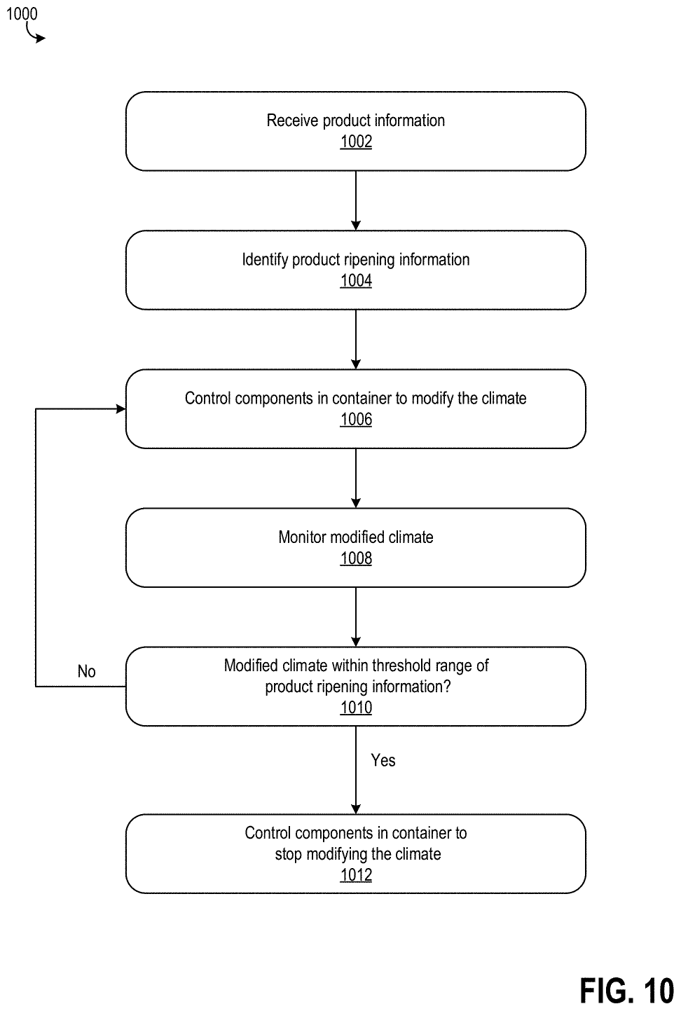

FIG. 10 is a flowchart of a process 1000 for modifying a climate of the shipping container based on product ripening information. The process 1000 can be performed by any one or more of the controllers described herein (e.g., the controller 112 in FIGS. 1A-B, the controller 202 in FIG. 2A, the controller 220 in FIG. 2B). For example, the process 1000 can be performed by a controller that is integrated into a shipping container. The process 1000 can also be performed by a controller that is part of a self-contained ripening agent unit. In some implementations, one or more blocks in the process 1000 can be performed by other computing devices or systems that are integrated in the container and/or separate from the container. For illustrative purposes, the process 1000 is described from a perspective of a controller.

Referring to the process 1000 in FIG. 10, the controller can receive product information in 1002. The product information can be received from computing systems and/or devices in communication with the controller, such as a computing device of an importer or producer of the product. The product information can include a place of origin, typical or normal ripening conditions associated with the product, preferred transit climates for the product, and other information about the product that can be useful to perform an optimal ripening process. Other information that can be useful can include seasonality, size of the product, and/or customer ripening preferences/specifications.

The controller can identify product ripening information in 1004. The product ripening information can be included in the received product information. The produce ripening information can include but is not limited to temperature, concentration, duration, and humidity levels that are preferred for ripening the particular product.

In 1006, the controller can control components in the container to modify the climate therein. The climate modifications can be based on the product ripening information. The climate modifications can also be based on other information in the received product information. Modifying the climate can include increasing a temperature inside the container to a temperature that is preferred for ripening the particular product. Modifying the climate can also include injecting a quantity or particular flow of a ripening agent into the container that can optimally ripen the product according to the product ripening information.

The controller can monitor the modified climate in 1008. As described throughout this disclosure, the controller can control one or more components to adjust the climate and maintain the climate within a threshold range that corresponds to the product ripening information. Therefore, in 1010, the controller can determine whether the modified climate is within the threshold range of the product ripening information. In some implementations, the controller can determine the threshold range based on the product ripening information. In some implementations, the product ripening information can include the desired threshold range for the ripening process. The threshold range can be associated with a desired temperature or temperature range at which to perform the ripening process. The threshold range can also be associated with a desired amount of the ripening agent that should be injected into the container to perform the ripening process. The threshold range can further be associated with a desired amount of time to perform the ripening process.

If the modified climate is not within the threshold range of the product ripening information, then 1006-1010 can be repeated until the modified climate is within the threshold range. In other words, 1006-1010 can be repeated until the ripening process is completed according to the product ripening information. If the modified climate is within the threshold range of the product ripening information, then the controller can control the components in the container to stop modifying the climate in 1012. In other words, the ripening process is complete based on the product ripening information. Components such as a ripening agent generator can be turned off so that no more ripening agent is injected into the container. Components such as vents can also be opened so that any remaining ripening agent in the container can be expelled from the container. Additionally, components such as a refrigeration unit can be activated to decrease a temperature in the container to a refrigerated state.

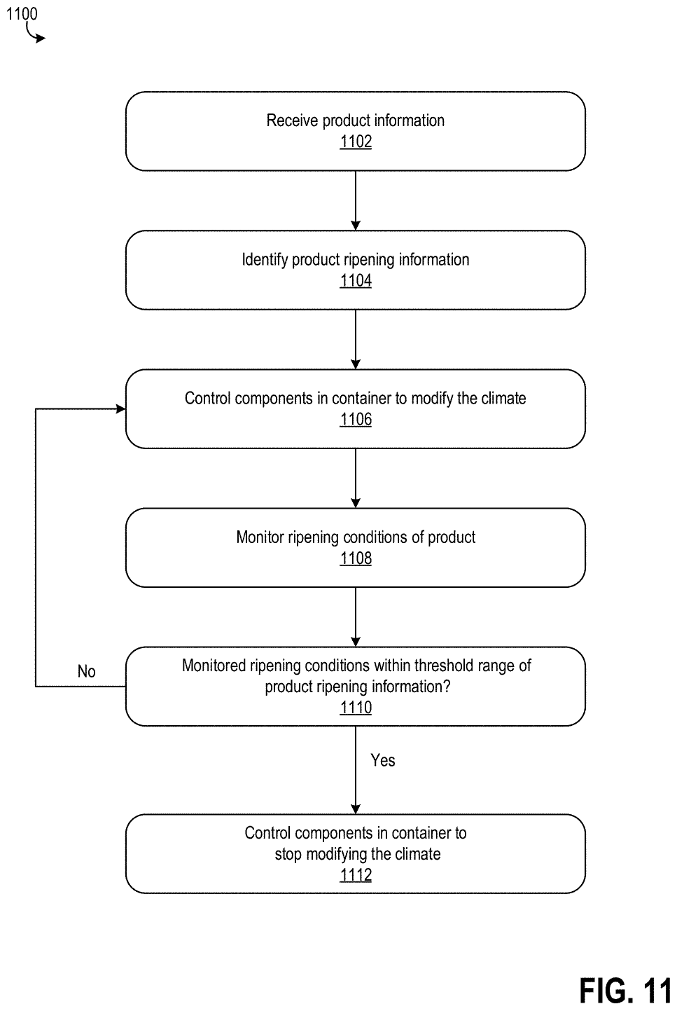

FIG. 11 is a flowchart of a process 1100 for modifying a climate of the shipping container based on monitored ripening conditions of produce in the shipping container. The process 1100 can be performed by any one or more of the controllers described herein (e.g., the controller 112 in FIGS. 1A-B, the controller 202 in FIG. 2A, the controller 220 in FIG. 2B). For example, the process 1100 can be performed by a controller that is integrated into a shipping container. The process 1100 can also be performed by a controller that is part of a self-contained ripening agent unit. In some implementations, one or more blocks in the process 1100 can be performed by other computing devices or systems that are integrated in the container and/or separate from the container. For illustrative purposes, the process 1100 is described from a perspective of a controller.

Referring to the process 1100 in FIG. 11, the controller can receive product information in 1102 (e.g., refer to block 1002 in FIG. 10). The controller can identify product ripening information in 1104 (e.g., refer to block 1004 in FIG. 10). The controller can then control components in the container to modify the climate in 1106 (e.g., refer to block 1006 in FIG. 10).

In 1108, the controller can monitor ripening conditions of the product. As described throughout this disclosure, sensors in the container can be configured to detect ripening agent levels in the container. One or more sensors can also be configured to detect ripening agent levels of the product in the container. One or more sensors can be configured to detect ripeness levels of the product. In some implementations, ripening conditions can be monitored based on real-time product ripening information. The product ripening information can be a variety of data and information, including but not limited to produce quality information, produce type, produce category, hyperspectral images of the produce, color, firmness, internal temperature of the produce, and/or volatile analysis. As an example, the controller can determine that the ripening process should take place for a predetermined amount of time. Monitoring the ripening conditions can include determining how much time has passed since the climate was modified in 1106 and how much time remains in the ripening process. As another example, monitoring the ripening conditions can include determining that an appropriate amount or flow rate of the ripening agent is injected into the container, where that amount or flow rate corresponds to the product ripening information. As yet other examples, monitoring the ripening conditions can include monitoring firmness, color, and/or volatile gases of the produce. Accordingly, nondestructive measures can be taken to monitor the ripening conditions. In some implementations, predetermined ripening conditions and control responses can be used to respond to current ripening agent levels in the container, instead of or as part of monitoring the ripening conditions.

The controller can determine whether the ripening conditions are within a threshold range of the product ripening information in 1110 (e.g., refer to block 1010 in FIG. 10). In other words, the controller can determine whether the product has been ripened to a preferred ripeness level that corresponds with the product ripening information.

If the monitored ripening conditions are not within the threshold range of the product ripening information, then 1106-1110 can be repeated until the conditions are within the threshold range. If the monitored ripening conditions are within the threshold range of the product ripening information, then the controller can control components in the container to stop modifying the climate in 1112 (e.g., refer to block 1112 in FIG. 10).

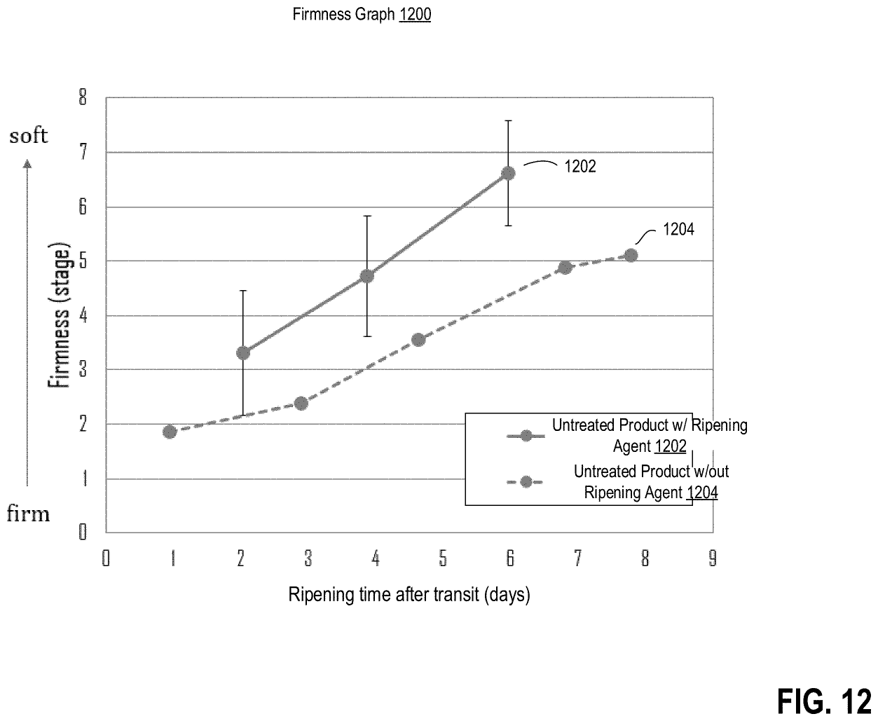

FIG. 12 is a graphical depiction 1200 of firmness of ethylene-ripened avocados versus ambient-ripened avocados. Firmness of the avocados is depicted in stages along a y axis of the graph 1200. Ripening time after transit is depicted in days along an x axis of the graph 1200. Untreated produce that ripen with a ripening agent are depicted as a solid line 1202 in the graph 1200. Untreated produce that ripen without the ripening agent are depicted as a dashed line 1204 in the graph 1200. In the example of FIG. 12, the produce are avocados. The ripening agent is ethylene gas.

The graph 1200 compares internal quality of avocados after transit based on whether the avocados are exposed to the ripening agent or not. The graph 1200 demonstrates that injecting a container of untreated avocados with the ripening agent, ethylene, results in a faster ripening process. The line 1202 indicates that by day 6, the untreated avocados that are exposed to ethylene have ripened so a softer firmness level. 6 days after transit, untreated avocados that are not exposed to ethylene ripen slower, and are at a considerably harder firmness level, as indicated by the line 1204. In comparison, untreated avocados that are not exposed to ethylene are still ripening by day 8, as indicated by the line 1204. The avocados in line 1204 reach a level 5 firmness around day 8 whereas the avocados in line 1202 reach the level 5 firmness between days 4 and 5. This demonstrates that untreated produce that are exposed to ethylene ripen at a faster rate than untreated produce that are not exposed to ethylene.

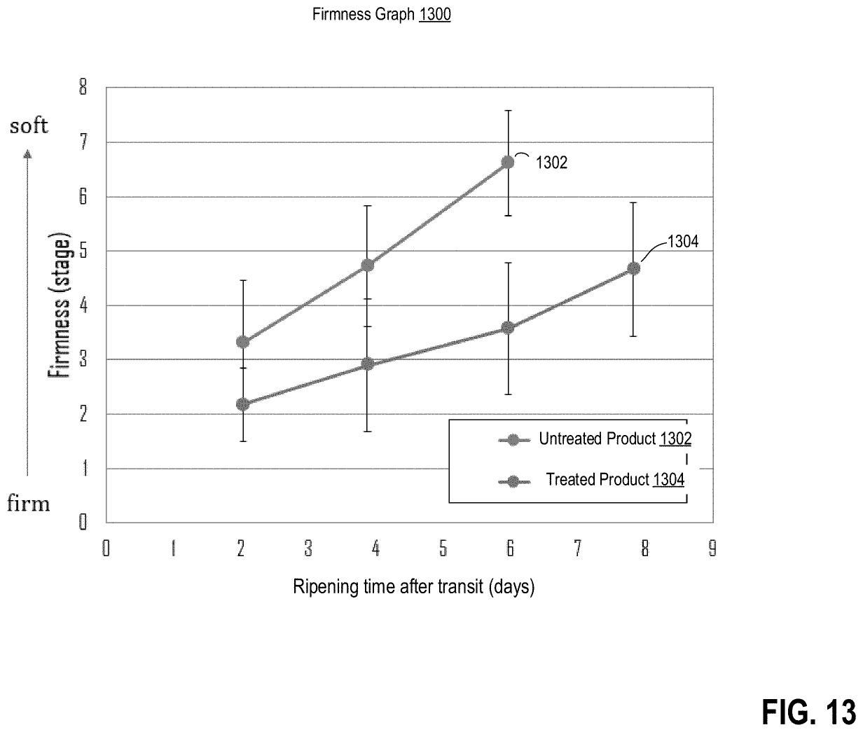

FIG. 13 is a graphical depiction 1300 of firmness of ethylene ripened treated avocados versus untreated avocados. The graph 1300 demonstrates an importance of coating produce, such as avocados, in a shelf-life extension coating solution and exposing such produce to a ripening agent, such as ethylene gas. Firmness of the avocados is depicted in stages along a y axis of the graph 1300. Ripening time after transit is depicted in days along an x axis of the graph 1300. Untreated produce are depicted as line 1302 in the graph 1300. Treated produce are depicted as line 1304 in the graph 1300. The produce are treated by coating them in the shelf-life extension coating solution.

The graph 1300 indicates that treated produce 1304 soften more slowly over time than untreated produce 1302. For example, as depicted in the graph 1300, at 6 days in ripening after transit, the untreated produce 1302 are between firmness stages 6 and 7 while the treated produce 1304 are between firmness states 3 and 4. This graph 1300 therefore demonstrates that coating the produce, such as avocados, in the shelf-life extension coating solution improves the ripening process and also maintains a firmness/freshness of the produce. The treated produce can remain fresher, riper, and firmer for longer periods of time.

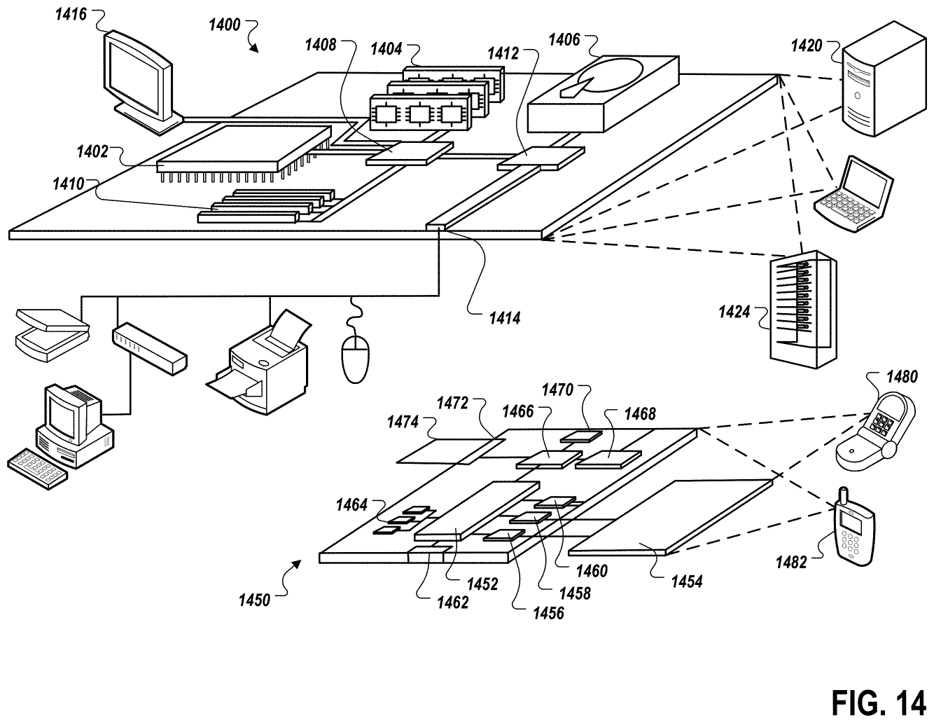

FIG. 14 shows an example of a computing device 1400 and an example of a mobile computing device that can be used to implement the techniques described here. The computing device 1400 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 1400 includes a processor 1402, a memory 1404, a storage device 1406, a high-speed interface 1408 connecting to the memory 1404 and multiple high-speed expansion ports 1410, and a low-speed interface 1412 connecting to a low-speed expansion port 1414 and the storage device 1406. Each of the processor 1402, the memory 1404, the storage device 1406, the high-speed interface 1408, the high-speed expansion ports 1410, and the low-speed interface 1412, are interconnected using various busses, and can be mounted on a common motherboard or in other manners as appropriate. The processor 1402 can process instructions for execution within the computing device 1400, including instructions stored in the memory 1404 or on the storage device 1406 to display graphical information for a GUI on an external input/output device, such as a display 1416 coupled to the high-speed interface 1408. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 1404 stores information within the computing device 1400. In some implementations, the memory 1404 is a volatile memory unit or units. In some implementations, the memory 1404 is a non-volatile memory unit or units. The memory 1404 can also be another form of computer-readable medium, such as a magnetic or optical disk.

The storage device 1406 is capable of providing mass storage for the computing device 1400. In some implementations, the storage device 1406 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 1404, the storage device 1406, or memory on the processor 1402.

The high-speed interface 1408 manages bandwidth-intensive operations for the computing device 1400, while the low-speed interface 1412 manages lower bandwidth-intensive operations. Such allocation of functions is exemplary only. In some implementations, the high-speed interface 1408 is coupled to the memory 1404, the display 1416 (e.g., through a graphics processor or accelerator), and to the high-speed expansion ports 1410, which can accept various expansion cards (not shown). In the implementation, the low-speed interface 1412 is coupled to the storage device 1406 and the low-speed expansion port 1414. The low-speed expansion port 1414, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 1400 can be implemented in a number of different forms, as shown in the figure. For example, it can be implemented as a standard server 1420, or multiple times in a group of such servers. In addition, it can be implemented in a personal computer such as a laptop computer 1422. It can also be implemented as part of a rack server system 1424. Alternatively, components from the computing device 1400 can be combined with other components in a mobile device (not shown), such as a mobile computing device 1450. Each of such devices can contain one or more of the computing device 1400 and the mobile computing device 1450, and an entire system can be made up of multiple computing devices communicating with each other.

The mobile computing device 1450 includes a processor 1452, a memory 1464, an input/output device such as a display 1454, a communication interface 1466, and a transceiver 1468, among other components. The mobile computing device 1450 can also be provided with a storage device, such as a micro-drive or other device, to provide additional storage. Each of the processor 1452, the memory 1464, the display 1454, the communication interface 1466, and the transceiver 1468, are interconnected using various buses, and several of the components can be mounted on a common motherboard or in other manners as appropriate.

The processor 1452 can execute instructions within the mobile computing device 1450, including instructions stored in the memory 1464. The processor 1452 can be implemented as a chipset of chips that include separate and multiple analog and digital processors. The processor 1452 can provide, for example, for coordination of the other components of the mobile computing device 1450, such as control of user interfaces, applications run by the mobile computing device 1450, and wireless communication by the mobile computing device 1450.

The processor 1452 can communicate with a user through a control interface 1458 and a display interface 1456 coupled to the display 1454. The display 1454 can be, for example, a TFT (Thin-Film-Transistor Liquid Crystal Display) display or an OLED (Organic Light Emitting Diode) display, or other appropriate display technology. The display interface 1456 can comprise appropriate circuitry for driving the display 1454 to present graphical and other information to a user. The control interface 1458 can receive commands from a user and convert them for submission to the processor 1452. In addition, an external interface 1462 can provide communication with the processor 1452, so as to enable near area communication of the mobile computing device 1450 with other devices. The external interface 1462 can provide, for example, for wired communication in some implementations, or for wireless communication in other implementations, and multiple interfaces can also be used.

The memory 1464 stores information within the mobile computing device 1450. The memory 1464 can be implemented as one or more of a computer-readable medium or media, a volatile memory unit or units, or a non-volatile memory unit or units. An expansion memory 1474 can also be provided and connected to the mobile computing device 1450 through an expansion interface 1472, which can include, for example, a SIMM (Single In Line Memory Module) card interface. The expansion memory 1474 can provide extra storage space for the mobile computing device 1450, or can also store applications or other information for the mobile computing device 1450. Specifically, the expansion memory 1474 can include instructions to carry out or supplement the processes described above, and can include secure information also. Thus, for example, the expansion memory 1474 can be provide as a security module for the mobile computing device 1450, and can be programmed with instructions that permit secure use of the mobile computing device 1450. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 1464, the expansion memory 1474, or memory on the processor 1452. In some implementations, the computer program product can be received in a propagated signal, for example, over the transceiver 1468 or the external interface 1462.

The mobile computing device 1450 can communicate wirelessly through the communication interface 1466, which can include digital signal processing circuitry where necessary. The communication interface 1466 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 1468 using a radio-frequency. In addition, short-range communication can occur, such as using a Bluetooth, WiFi, or other such transceiver (not shown). In addition, a GPS (Global Positioning System) receiver module 1470 can provide additional navigation- and location-related wireless data to the mobile computing device 1450, which can be used as appropriate by applications running on the mobile computing device 1450.

The mobile computing device 1450 can also communicate audibly using an audio codec 1460, which can receive spoken information from a user and convert it to usable digital information. The audio codec 1460 can likewise generate audible sound for a user, such as through a speaker, e.g., in a handset of the mobile computing device 1450. Such sound can include sound from voice telephone calls, can include recorded sound (e.g., voice messages, music files, etc.) and can also include sound generated by applications operating on the mobile computing device 1450.

The mobile computing device 1450 can be implemented in a number of different forms, as shown in the figure. For example, it can be implemented as a cellular telephone 1480. It can also be implemented as part of a smart-phone 1482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A method for ripening produce in a container during transit, the method comprising:
maintaining, by a controller, an initial refrigerated climate in the container, wherein the container is in transit to a destination location and contains the produce;
detecting, by the controller, a first climate modification event during transit of the container to the destination location;
controlling, by the controller and in response to detecting the first climate modification event, one or more automated vents in the container to an open state that exposes an interior of the container to an external environment, wherein the automated vents are maintained in the open state until a temperature within the container increases from an initial refrigerated climate to at least a predetermined temperature value;
controlling, by the controller and in response to the temperature in the container reaching the predetermined temperature value, a ripening agent generator to inject a ripening agent into the container;
continuously monitoring and controlling, by the controller, the ripening agent generator to maintain a target concentration of the ripening agent in the container;
detecting, by the controller, a second climate modification event;
controlling, by the controller and in response to detecting the second climate modification event, the ripening agent generator to stop injecting the ripening agent into the container;
controlling, by the controller, a refrigeration unit to activate to lower the temperature in the container to the initial refrigerated climate; and
maintaining, by the controller, the initial refrigerated climate until arrival at a destination location of the container.

2. The method of claim 1, wherein the ripening agent is ethylene gas.

3. The method of claim 1, wherein detecting (i) the first climate modification event and (ii) the second climate modification event comprises receiving, by the controller and from a plurality of sensors positioned throughout the container, indications of at least one of temperature, humidity, CO₂, O₂, ripening agent, and ripeness level in the container.

4. The method of claim 1, wherein the initial refrigerated climate includes a temperature range of 0° Celsius to 5° Celsius.

5. The method of claim 1, wherein the predetermined temperature value includes a temperature range of 15° Celsius to 22° Celsius.

6. The method of claim 1, wherein the ripening agent is injected into the container at a rate between 1 ppm and 200 ppm.

7. The method of claim 2, further comprising:
receiving, by the controller and from the plurality sensors, indications of CO₂ and O₂ levels in the container;
determining, by the controller and based on the CO₂ and O₂ levels, a ratio of CO₂ to O₂ in the container; and
controlling, by the controller and based on the ratio of CO₂ to O₂ exceeding a threshold ratio range, one or more of the vents to open to adjust levels of one or more of the CO₂ and the O₂ in the container.

8. The method of claim 1, wherein detecting a first climate modification event comprises:
receiving, by the controller, information about a current location of the container, a travel route, and the destination location;
identifying, by the controller and based on the information, travel conditions along the travel route from the current location of the container to the destination location;
predicting an estimated remaining time in transit from the current location of the container to the destination location; and
detecting, by the controller, the first climate modification event based on the estimated remaining time in transit being within a threshold arrival range.

9. The method of claim 8, wherein (i) the identified travel conditions include weather conditions and traffic along the travel route and (ii) the information about the current location of the container includes a GPS location of the container.

10. The method of claim 1, wherein controlling a ripening agent generator to inject a ripening agent into the container comprises:
receiving, by the controller and from one or more sensors in the container, indications of a ripeness level of the product;
receiving, by the controller, information about the product in the container, wherein the information includes a place of origin, a period of time for ripening, and a type of the product;
determining, by the controller, that the ripeness level of the product corresponds to the received information about the product; and
controlling, by the controller and based on determining that the ripeness level of the product corresponds to the received information about the product, the ripening agent generator to stop injecting the ripening agent into the container.

11. The method of claim 1, further comprising coating the produce before transit in the container in a shelf-life extension coating solution.

12. The method of claim 7, wherein the threshold ratio range is 6% CO₂ to 4% O₂.

13. The method of claim 1, wherein detecting a first climate modification event comprises determining, by the controller, that a distance between a current location of the container and the destination location is within a threshold distance range.

14. The method of claim 8, wherein the threshold arrival range is three days from arrival to the destination location.

15. The method of claim 1, wherein continuously monitoring a concentration of the ripening agent in the container comprises controlling, by the controller and based on the concentration of the ripening agent exceeding a threshold ripening range, one or more of the vents to open to release a predetermined amount of the ripening agent from the container.

16. The method of claim 15, further comprising controlling, by the controller and based on the concentration of the ripening agent being less than the threshold ripening range, the ripening agent generator to inject an additional predetermined quantity of the ripening agent into the container.

17. The method of claim 16, wherein detecting a second climate modification event comprises determining, by the controller, that the concentration of the ripening agent is within the threshold ripening range.

18. A system for ripening a product in a container during transit, the system comprising:
a container for storing the product in transit, the container having:
a plurality of sensors;
a plurality of vents; and
a first controller configured to receive information from the sensors and control the plurality of vents; and
a self-contained ripening agent unit for ripening the product in the container during transit, the unit having:
at least one ripening agent sensor;
a ripening agent generator; and
a second controller configured to receive information from the at least one ripening agent sensor and control the ripening agent generator, wherein the second controller is in communication with the first controller, wherein the second controller is configured to:
maintain an initial refrigerated climate in the container, wherein the container is in transit to a destination location and contains the product;
detect a first climate modification event during transit of the container to the destination location;
control, in response to detecting the first climate modification event, one or more automated vents in the container to an open state that exposes an interior of the container to an external environment, wherein the automated vents are maintained in the open state until a temperature within the container increases from an initial refrigerated climate to at least a predetermined temperature value;
control, in response to the temperature in the container reaching the predetermined temperature value, a ripening agent generator to inject a ripening agent into the container;
continuously monitor and control the ripening agent generator to maintain a target concentration of the ripening agent in the container;
detect a second climate modification event;
control, in response to detecting the second climate modification event, the ripening agent generator to stop injecting the ripening agent into the container;
control a refrigeration unit to activate to lower the temperature in the container to the initial refrigerated climate; and
maintain the initial refrigerated climate until arrival at a destination location of the container.

19. The system of claim 18, wherein the ripening agent is ethylene gas.

20. A system for ripening a product in a container during transit, the system comprising:
a container for storing the product in transit, the container having:
a plurality of sensors;
a plurality of vents;
a ripening agent generator; and
a controller configured to receive information from the plurality of sensors and control the plurality of vents and the ripening agent generator, wherein the controller is configured to:
maintain an initial refrigerated climate in the container, wherein the container is in transit to a destination location and contains the product;
detect a first climate modification event during transit of the container to the destination location;
control, in response to detecting the first climate modification event, one or more automated vents in the container to an open state that exposes an interior of the container to an external environment, wherein the automated vents are maintained in the open state until a temperature within the container increases from an initial refrigerated climate to at least a predetermined temperature value;
control, in response to the temperature in the container reaching the predetermined temperature value, a ripening agent generator to inject a ripening agent into the container;
continuously monitor and control the ripening agent generator to maintain a target concentration of the ripening agent in the container;
detect a second climate modification event;
control, in response to detecting the second climate modification event, the ripening agent generator to stop injecting the ripening agent into the container;
control a refrigeration unit to activate to lower the temperature in the container to the initial refrigerated climate; and
maintain the initial refrigerated climate until arrival at a destination location of the container.
